(19) United States
(12) Patent Application Publication
(10) Pub. No.: US 2025/0066527 A1
(43) Pub. Date: Feb. 27, 2025

(54) CROSS-LINKABLE ION EXCHANGE POLYMERS, MEMBRANES AND IONOMERS

(71) Applicant: UCHICAGO ARGONNE, LLC, Chicago, IL (US)

(72) Inventors: Meltem Urgun-Demirtas, Naperville, IL (US); Chaoyi Ba, Schaumburg, IL (US); Shu Xu, Bolingbrook, IL (US)

(21) Appl. No.: 18/812,713

(22) Filed: Aug. 22, 2024

Related U.S. Application Data
(60) Provisional application No. 63/534,043, filed on Aug. 22, 2023.

(51) Int. Cl. C08G 10/00; B01J 39/05; B01J 39/19; B01J 41/05; B01J 41/13; B01J 47/12; C08J 5/22; H01M 8/10; H01M 8/1004; H01M 8/1027; H01M 8/103

(52) U.S. Cl. CPC C08G 10/00; B01J 39/05; B01J 39/19; B01J 41/05; B01J 41/13; B01J 47/12; C08J 5/2287; H01M 8/1004; H01M 8/1027; H01M 8/103; H01M 2008/1095

(57) ABSTRACT

A polymer comprising a plurality of repeat units of formula (I)

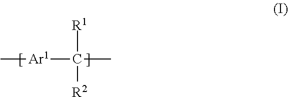

or formula (IV)

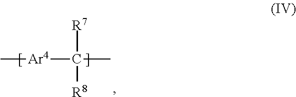

wherein each Ar¹ and Ar⁴ is a unit comprising two or more aromatic groups; Ar¹ comprises at least one cross-linkable group; Ar⁴ comprises a substituent selected from —SO₃H, —CO₂H, —PO₃H₂, and salts thereof; R¹ and R², and R⁷ and R⁸, are independently selected from C₁₋₆ alkyl, C₁₋₆ haloalkyl, C₃₋₁₀ cycloalkyl, C₃₋₁₀ heterocycloalkyl, aryl, and heteroaryl, each optionally substituted, or R¹ and R², or R⁷ and R⁸, together with the carbon atom to which they are attached, form a carbocycle or heterocycle, provided that at least one of R⁷ and R⁸ contains an amide group or at least one geminal pair of R⁷ and R⁸, together with the carbon atom to which they are attached, forms a carbocycle or heterocycle that contains an amide group; and membranes and membrane electrode assemblies including same.

### CROSS-REFERENCE TO RELATED APPLICATION

The benefit under 35 U.S.C. § 119(e) of U.S. Provisional Patent Application No. 63/534,043, filed Aug. 22, 2023, is claimed and the entire disclosure thereof is incorporated herein by reference.

### STATEMENT OF GOVERNMENT SUPPORT

This invention was made with government support under Contract No. DE-AC02-06CH11357 awarded by the United States Department of Energy to UChicago Argonne, LLC, operator of Argonne National Laboratory. The government has certain rights in the invention.

### FIELD

The present disclosure relates generally to cross-linkable polymers and to membranes and ionomers comprising cross-linkable polymers. More particularly, the disclosure relates to cross-linkable polymers suitable for use as membranes or ionomers for anion exchange, proton exchange, nanofiltration, or gas separation applications.

### BACKGROUND

Ion-conducting (i.e., ion exchange) membranes and ionomers are critical components in electrochemical applications (for instance, fuel cells and flow batteries), water/CO₂ electrolysis, and water desalination. Existing proton exchange membranes (PEMs) and anion exchange membranes (AEMs) for such applications can generally be improved in one or more of conductivity, selectivity, mechanical stability, and cost. For instance, perfluorosulfonic acid-based PEMs can suffer from low proton conductivity, low long-term stability due to side chain reactivity, and high cost due in part to their high fluorine content. Many commercial AEMs exhibit high OH⁻ conductivity and good long-term stability, though they can be expensive and their solubility, conductivity, selectivity, and/or long-term stability can generally still be improved.

For electrochemical devices having multiple ion-conducting polymer layers, such as the membrane and catalyst layers of a membrane electrode assembly, improving the contact efficiency between adjacent layers can improve device conductivity and reduce impedance, providing higher energy efficiency. Generally, the polymers making up the layers of electrochemical devices are not specifically designed to provide good interlayer contact.

Accordingly, there is a need in the art to provide ion-conducting polymers that are chemically stable, can be formed into membranes having high physical stability, and can provide multilayer electrochemical devices having generally improved interlayer contact compared to that of existing devices.

### SUMMARY

Described herein are cross-linkable polymers suitable for use in anion exchange, proton exchange, nanofiltration, and gas separation applications. The polymers contain one or more cross-linkable functional groups, and the polymers can be subjected to cross-linking conditions to generate a plurality of cross-links between polymer chains. The polymers can also contain functional groups suitable for nanofiltration, gas separation, anion exchange, or proton exchange. Also described herein are membranes formed from polymers according to the disclosure.

The disclosure provides a polymer comprising a plurality of repeat units of formula (1):

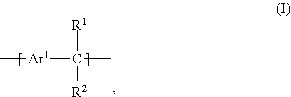

wherein each Ar¹ comprises two or more aromatic rings and at least one cross-linkable group, and each R¹ and R² are independently selected from C₁₋₆ alkyl, C₁₋₆ haloalkyl, C₃₋₁₀ cycloalkyl, C₃₋₁₀ heterocycloalkyl, aryl, and heteroaryl, each optionally having one or more substituents selected from halo, alkyl, aryl, amino, and quaternary ammonium, or R¹ and R², together with the carbon atom to which they are attached, form a carbocycle or heterocycle.

The disclosure also provides a polymer comprising a plurality of repeat units of formula (1) and a plurality of repeat units of formula (II):

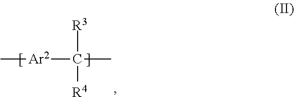

wherein each Ar² is independently a unit comprising two or more aromatic rings and Ar² has a substituent comprising —SO₃H, —CO₂H, —PO₃H₂, or a salt of any of the foregoing, and each R³ and R⁴ is independently selected from C₁₋₆ alkyl, C₁₋₆ haloalkyl, C₃₋₁₀ cycloalkyl, C₃₋₁₀ heterocycloalkyl, aryl, and heteroaryl, each optionally having one or more substituents selected from halo, alkyl, aryl, amino, and quaternary ammonium, or R³ and R⁴, together with the carbon atom to which they are attached, form a carbocycle or heterocycle. Ar² can comprise two or more substituents comprising —SO₃H, —CO₂H, —PO₃H₂, or a salt of any of the foregoing. When Ar² comprises two or more substituents comprising —SO₃H, —CO₂H, —PO₃H₂, or a salt of any of the foregoing, the two or more substituents can be identical.

The disclosure also provides a polymer comprising a plurality of repeat units of formula (1), optionally a plurality of repeat units of formula (II), and a plurality of repeat units of formula (III):

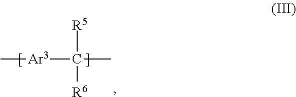

wherein each Ar³ is independently a unit comprising two or more aromatic rings and does not contain a cross-linkable group, and each R⁵ and R⁶ is independently selected from C₁₋₆ alkyl, C₁₋₆ haloalkyl, C₃₋₁₀ cycloalkyl, C₃₋₁₀ heterocycloalkyl, aryl, and heteroaryl, each optionally having one or more substituents selected from halo, alkyl, aryl, amino, and quaternary ammonium, or R⁵ and R⁶, together with the carbon atom to which they are attached, form a carbocycle or heterocycle.

The disclosure also provides a polymer comprising a plurality of repeat units of formula (IV):

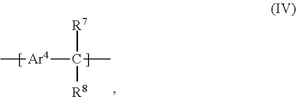

wherein each Ar⁴ is independently a unit comprising two or more aromatic rings and Ar⁴ has a substituent comprising —SO₃H, —CO₂H, —PO₃H₂, amine, quaternary ammonium, or a salt of any of the foregoing, and Ar⁴ does not contain a cross-linkable group, and each R⁷ and R⁸ is independently selected from C₁₋₆ alkyl, C₁₋₆ haloalkyl, C₃₋₁₀ cycloalkyl, C₃₋₁₀ heterocycloalkyl, aryl, and heteroaryl, each optionally having one or more substituents selected from halo, alkyl, aryl, amino, and quaternary ammonium, or R⁷ and R⁸, together with the carbon atom to which they are attached, form a carbocycle or heterocycle, provided that at least one of R⁷ and R⁸ contains an amide group or at least one pair of R⁷ and R⁸, together with the carbon atom to which they are attached, forms a carbocycle or heterocycle that contains an amide group. Ar⁴ can comprise two or more substituents comprising —SO₃H, —CO₂H, —PO₃H₂, amine, quaternary ammonium, or a salt of any of the foregoing. When Ar⁴ comprises two or more substituents comprising —SO₃H, —CO₂H, —PO₃H₂, amine, quaternary ammonium, or a salt of any of the foregoing, the two or more substituents can be identical.

The disclosure also provides a polymer comprising a plurality of repeat units of formula (IV) and a plurality of repeat units of formula (V):

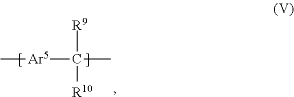

wherein each Ar⁵ is comprises two or more aromatic rings and does not contain a cross-linkable group, and each R⁹ and R¹⁰ is independently selected from C₁₋₆ alkyl, C₁₋₆ haloalkyl, C₃₋₁₀ cycloalkyl, C₃₋₁₀ heterocycloalkyl, aryl, and heteroaryl, each optionally having one or more substituents selected from halo, alkyl, aryl, and amide, or R⁹ and R¹⁰, together with the carbon atom to which they are attached, form a carbocycle or heterocycle, wherein at least one pair of R⁹ and R¹⁰, together with the carbon atom to which they are attached, form a carbocycle or heterocycle and the carbocycle or heterocycle has an amide substituent.

The disclosure also provides a membrane comprising a polymer according to the disclosure.

The disclosure also provides a membrane electrode assembly comprising an anode layer, an ion exchange membrane, and a cathode layer, any or all of which can comprise a polymer according to the disclosure.

For the compositions and methods described herein, optional features, including but not limited to components, compositional ranges thereof, substituents, conditions, and steps are contemplated to be selected from the various aspects, embodiments, and examples provided herein.

Further aspects and advantages will be apparent to those of ordinary skill in the art from a review of the following detailed description, taken in conjunction with the drawings. While the polymers, membranes, and their methods of making and use are susceptible of embodiments in various forms, the description hereafter includes specific embodiments with the understanding that the disclosure is illustrative and is not intended to limit the invention to the specific embodiments described herein.

### BRIEF DESCRIPTION OF THE DRAWINGS

For further facilitating the understanding of the present invention, six drawing figures are appended hereto.

FIG. 1 shows a generic reaction scheme for synthesizing a polymer according to the disclosure.

FIG. 2 shows a reaction scheme for synthesizing an anion exchange polymer according to the disclosure.

FIG. 3 shows the composition and structure of the proton exchange polymer according to Example 3a.

FIG. 4 shows a schematic representation of a membrane electrode assembly of the disclosure.

FIG. 5 shows a schematic representation of an integrated membrane electrode assembly according to the disclosure.

FIG. 6 shows a reaction scheme for synthesizing FLSN monomer.

FIG. 7 shows reaction schemes for synthesizing polymers described in Example 6.

FIG. 8 shows reaction schemes for synthesizing PIDF and PIDF-PA polymers.

FIGS. 9a and 9b show reaction schemes for synthesizing PF-SA monomer and PIPF-SA polymer, respectively.

FIGS. 10a and 10b show reaction schemes for synthesizing PF-N3 monomer and PIPF-QA polymer, respectively.

FIG. 11 shows reaction schemes for synthesizing PIF-Boc polymer and a microporous PIF/PIF-Boc membrane.

### DETAILED DESCRIPTION

The disclosure provides cross-linkable polymers suitable for use in anion exchange, proton exchange, nanofiltration, and gas separation applications. The disclosure also provides membranes comprising polymers of the disclosure and membrane electrode assemblies comprising polymers and/or membranes of the disclosure. The polymers contain one or more cross-linkable functional groups, and the polymers can be subjected to cross-linking conditions to generate a plurality of cross-links between polymer chains. The polymers, and membranes comprising the polymers, can also contain functional groups suitable for nanofiltration, gas separation, anion exchange, or proton exchange.

As described herein, polymers of the disclosure can be prepared by polymerizing one or more aromatic group-containing monomers and one or more ketone-containing monomers. Cross-linkable groups can be provided on the polymer by including in the polymerization at least one monomer containing a cross-linkable group. Adjusting the relative amount of monomer containing a cross-linkable group included in the polymerization can enable tunability of the degree of cross-linking of the resulting polymer. Additionally or alternatively, cross-linkable groups can be provided on the polymer by performing a post-polymerization reaction that adds cross-linkable groups to the polymer. Similarly, anion exchange groups or proton exchange groups can be provided on the polymer by including in the polymerization at least one monomer containing an anion exchange group or a proton exchange group or by including in the polymerization at least one monomer containing a group that can be converted to an anion exchange group or a proton exchange group by a post-polymerization reaction.

“Comprising” as used herein means that various components, ingredients or steps that can be conjointly employed in practicing the present disclosure. Accordingly, the term “comprising” encompasses the more restrictive terms “consisting essentially of” and “consisting of.” The present compositions can comprise, consist essentially of, or consist of any of the required and optional elements disclosed herein. The invention illustratively disclosed herein suitably may be practiced in the absence of any element or step which is not specifically disclosed herein.

All ranges set forth herein include all possible subsets of ranges and any combinations of such subset ranges. By default, ranges are inclusive of the stated endpoints, unless stated otherwise. Where a range of values is provided, it is understood that each intervening value between the upper and lower limit of that range and any other stated or intervening value in that stated range, is encompassed within the disclosure. The upper and lower limits of these smaller ranges may independently be included in the smaller ranges, and are also encompassed within the disclosure, subject to any specifically excluded limit in the stated range. Where the stated range includes one or both of the limits, ranges excluding either or both of those included limits are also contemplated to be part of the disclosure.

The dimensions and values disclosed herein are not to be understood as being strictly limited to the exact numerical values recited. Instead, unless otherwise specified, each such dimension is intended to include both the recited value and a functionally equivalent range surrounding that value. For example, a dimension disclosed as “15 mm” is intended to include “about 15 mm,” and “about 15 mm” can include a range of from 14.5 mm to 15.4 mm, e.g., by numerical rounding.

The term “ionomer” is used herein to refer to a polymer which has a plurality of substituents suitable for anion exchange or proton exchange and which is soluble or partially soluble in one or more polar solvents.

As used herein, “halo” as a substituent selected from F, Cl, Br, and I. As used herein, “amine” or “amino” as a substituent refers to NH₂, optionally in which one or two NH₂ hydrogens are replaced with alkyl, aryl, or other substituents. As used herein, “quaternary ammonium” as a substituent refers to a nitrogen having four substituents and bearing a positive charge.

As used herein, the term “alkyl,” by itself or as part of another substituent, means, unless otherwise stated, a hydrocarbon having the number of carbon atoms designated (i.e., “C₁₋₆ alkyl” means a hydrocarbon having one to six carbon atoms), including straight and branched hydrocarbon groups. Examples include methyl, ethyl, propyl, isopropyl, n-butyl, isobutyl, sec-butyl, tert-butyl, n-pentyl, neopentyl, and hexyl. As used herein, the terms “Me” and “CH₃” refer to a methyl group and should be considered interchangeable.

As used herein, the term “haloalkyl” means, unless otherwise stated, an alkyl group having one or more halo substituents selected from F, Cl, Br, and I in place of one or more hydrogen substituents on the carbon chain. For instance, “C₁₋₆ haloalkyl” means an alkyl group having one to six carbon atoms wherein one or more hydrogen substituents is replaced with F, Cl, Br, or I. Examples include fluoromethyl, difluoromethyl, and trifluoromethyl.

As used herein, the term “cycloalkyl” means, unless otherwise stated, a cyclic hydrocarbon having a carbocycle having the number of carbon atoms designated (i.e., “C₃₋₁₀ cycloalkyl” means a carbocycle containing three to ten carbon atoms). Examples include cyclopropyl, cyclobutyl, cyclopentyl, and cyclohexyl.

As used herein, the term “heterocycloalkyl” means, unless otherwise stated. a cycloalkyl group in which one or more of the carbon atoms in the carbocycle is replaced by a heteroatom selected from N, O, and S. Examples include piperidinyl, pyrollidinyl, tetrahydropyranyl, and tetrahydrofuryl.

As used herein, the term “aryl,” by itself or as part of another substituent, means, unless otherwise stated, an aromatic carbocyclic system containing one or more rings. Such rings may be attached in a pendant manner, such as biphenyl, or may be fused, such as naphthyl. Further examples include phenyl and anthracyl.

As used herein, the term “heteroaryl” means, unless otherwise stated, an aryl group in which one or more of the carbon atoms in the carbocyclic system is replaced by a heteroatom selected from N, O, and S. Examples include pyridinyl, pyrrol-2-yl, pyrrol-3-yl, furyl, thiophen-2-yl, and thiophen-3-yl.

The disclosure provides a polymer comprising a plurality of repeat units of formula (1):

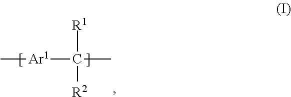

wherein each Ar¹ is independently a unit comprising two or more aromatic rings and at least one cross-linkable group selected from a terminal C═C double bond, an internal C═C double bond that is not part of an aryl ring, a C—C triple bond, a ketone, and a combination thereof; and each R¹ and R² is independently selected from C₁₋₆ alkyl, C₁₋₆ haloalkyl, C₃₋₁₀ cycloalkyl, C₃₋₁₀ heterocycloalkyl, aryl, and heteroaryl, each optionally having one or more substituents selected from halo, alkyl, aryl, amino, and quaternary ammonium, or R¹ and R², together with the carbon atom to which they are attached, form a carbocycle or heterocycle.

Polymers of the disclosure can comprise repeat units of formula (1) having one or more types of cross-linking groups. At least one Ar¹ can comprise an internal C═C double bond that is not part of an aryl ring. At least one Ar¹ can comprise a terminal C═C double bond. At least one Ar¹ can comprise a C—C triple bond. At least one Ar¹ can comprise a ketone group. All Ar¹ can comprise an internal C═C double bond that is not part of an aryl ring. All Ar¹ can comprise a terminal C═C double bond. All Ar¹ can comprise a C—C triple bond. All Ar¹ can comprise a ketone group. Polymers of the disclosure can include one Ar¹ unit or a combination of different Ar¹ units. For instance, polymers of the disclosure can include Ar¹ units independently selected from, but not limited to,

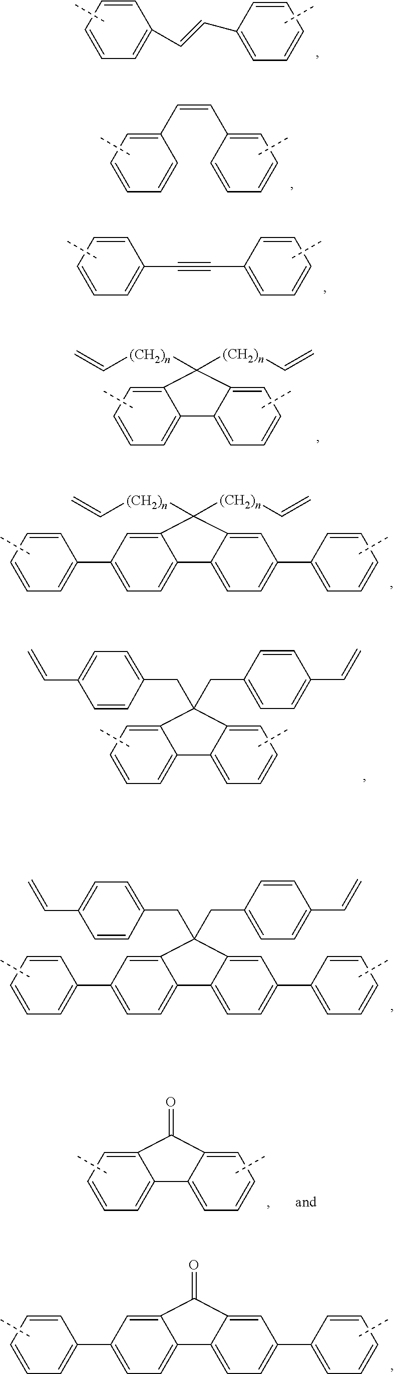

wherein each n is independently selected from 1, 2, 3, 4, 5, and 6, and where each dotted line indicates a bond between a carbon of the aromatic ring from which the dotted line extends and the carbon on a neighboring

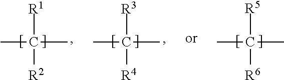

monomer unit. For instance, one dotted line can indicate a bond between a carbon of the aromatic ring from which the dotted line extends and the carbon on the neighboring

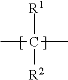

monomer unit in the repeat unit of formula (1), and the other dotted line can indicate a bond between a carbon of the aromatic ring from which the dotted line extends and the carbon of a

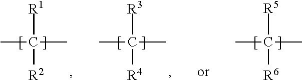

monomer unit on a neighboring repeat unit of formula (I), (II), or (Ill), respectively.

Each geminal pair of R¹ and R² can independently be identical or different. For each geminal pair of R¹ and R², R¹ and R² can independently be identical or different from each other.

At least one R¹ can be C₁₋₆ alkyl. At least one R¹ can be C₁₋₆ haloalkyl. At least one R¹ can be C₃₋₁₀ cycloalkyl. At least one R¹ can be C₃₋₁₀ heterocycloalkyl. At least one R¹ can be aryl. At least one R¹ can be heteroaryl. At least one R² can be C₁₋₆ alkyl. At least one R² can be C₁₋₆ haloalkyl. At least one R² can be C₃₋₁₀ cycloalkyl. At least one R² can be C₃₋₁₀ heterocycloalkyl. At least one R² can be aryl. At least one R² can be heteroaryl. All R¹ can be C₁₋₆alkyl. All R¹ can be C₁₋₆ haloalkyl. All R¹ can be C₃₋₁₀ cycloalkyl. All R¹ can be C₃₋₁₀ heterocycloalkyl. All R¹ can be aryl. All R¹ can be heteroaryl. All R² can be C₁₋₆ alkyl. All R² can be C₁₋₆ haloalkyl. All R² can be C₃₋₁₀ cycloalkyl. All R² can be C₃₋₁₀ heterocycloalkyl. All R² can be aryl. All R² can be heteroaryl. At least one geminal pair of R¹ and R², together with the carbon atom to which they are attached, can form a carbocycle. All geminal pairs of R¹ and R², together with the carbon atom to which they are attached, can form carbocycles. At least one geminal pair of R¹ and R² together with the carbon atom to which they are attached can form a heterocycle. All geminal pairs of R¹ and R² together with the carbon atom to which they are attached can form heterocycles. At least one geminal pair of R¹ and R² can be CF₃ and phenyl. At least one geminal pair of R¹ and R² can be CF₃ and methyl.

At least one of R¹ and R² can be substituted with a quaternary ammonium substituent or at least one geminal pair of R¹ and R² together with the carbon atom to which they are attached can form a carbocycle or heterocycle having a quaternary ammonium substituent. For instance, at least one of R¹ and R² can be

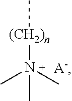

or at least one of R¹ and R² can be

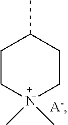

or at least one geminal pair of R¹ and R² can be CF₃ and

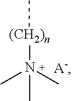

or at least one geminal pair of R¹ and R² can be CF₃ and

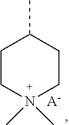

wherein each n is independently selected from 1, 2, 3, 4, 5, and 6, and each A is independently selected from OH, C₁, Br, and I, and wherein the dotted line indicates the C—R¹ or C—R² bond of the

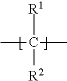

monomer unit. For instance, at least one geminal pair of R¹ and R² together with the carbon atom to which they are attached can be

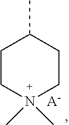

wherein A is selected from OH, C1, Br, and I, and wherein the dotted lines indicate C—R¹ or C—R² bonds, such that the geminal pair of R¹ and R² together with the carbon atom to which they are attached form a heterocycle having a quaternary ammonium substituent.

The disclosure also provides a cross-linkable polymer comprising a plurality of repeat units of formula (1) and a plurality of repeat units of formula (II):

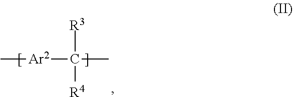

wherein each Ar² is independently a unit having two or more aromatic rings and at least one substituent selected from —SO₃H, —CO₂H, —PO₃H₂, a salt of any of the foregoing, and a combination of any of the foregoing; and each R³ and R⁴ is independently selected from C₁₋₆ alkyl, C₁₋₆ haloalkyl, C₃₋₁₀ cycloalkyl, C₃₋₁₀ heterocycloalkyl, aryl, and heteroaryl, each optionally having one or more substituents selected from halo, alkyl, aryl, amino, and quaternary ammonium, or R³ and R⁴, together with the carbon atom to which they are attached, form a carbocycle or heterocycle.

Polymers of the disclosure can comprise a plurality of repeat units of formula (II) having one or more —SO₃H, —CO₂H, —PO₃H₂ substituents. At least one Ar² can comprise —SO₃H, —CO₂H, or —PO₃H₂. At least one Ar² can comprise —SO₃H. At least one Ar² can comprise —CO₂H. At least one Ar² can comprise —PO₃H₂. All Ar² can comprise —SO₃H. All Ar² can comprise —CO₂H. All Ar² can comprise —PO₃H₂. Ar² can be selected from, but is not limited to,

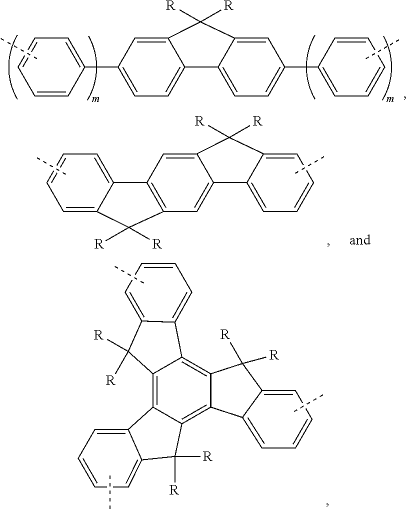

wherein each R is independently selected from C₁₋₆alkyl-SO₃H, C₁₋₆alkyl-CO₂H, C₁₋₆alkyl-PO₃H₂, and salts thereof; each m is independently 0 or 1; and the dotted lines indicate bonds between a carbon of the aromatic ring from which the dotted line extends and the carbon on a neighboring

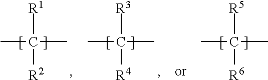

monomer unit, provided that when m is 0, the dotted lines are considered to extend from the two aromatic rings (e.g.,

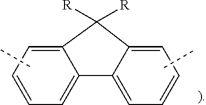

At least one Ar² can be

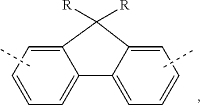

wherein R is C₁₋₆alkyl-SO₃H or a salt thereof, or wherein R is C₁₋₆alkyl-CO₂H or a salt thereof, or wherein R is C₁₋₆alkyl-PO₃H₂ or a salt thereof. At least one Ar² can be

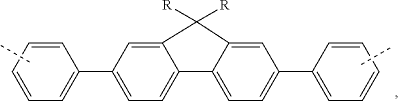

wherein R is C₁₋₆alkyl-SO₃H or a salt thereof, or wherein R is C₁₋₆alkyl-CO₂H or a salt thereof, or wherein R is C₁₋₆alkyl-PO₃H₂ or a salt thereof. At least one Ar² can be

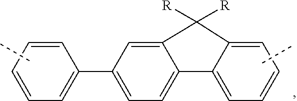

wherein R is C₁₋₆alkyl-SO₃H or a salt thereof, or wherein R is C₁₋₆alkyl-CO₂H or a salt thereof, or wherein R is C₁₋₆alkyl-PO₃H₂ or a salt thereof. At least one Ar² can be

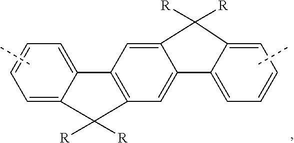

wherein R is C₁₋₆alkyl-SO₃H or a salt thereof, or wherein R is C₁₋₆alkyl-CO₂H or a salt thereof, or wherein R is C₁₋₆alkyl-PO₃H₂ or a salt thereof. At least one Ar² can be

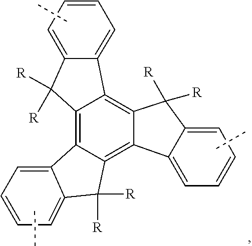

wherein R is C₁₋₆alkyl-SO₃H or a salt thereof, or wherein R is C₁₋₆alkyl-CO₂H or a salt thereof, or wherein R is C₁₋₆alkyl-PO₃H₂ or a salt thereof. All Ar² can be

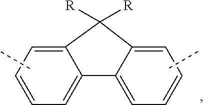

wherein R is C₁₋₆alkyl-SO₃H or a salt thereof, or wherein R is C1-alkyl-CO₂H or a salt thereof, or wherein R is C₁₋₆alkyl-PO₃H₂ or a salt thereof. All Ar² can be

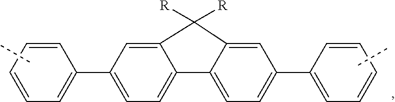

wherein R is C₁₋₆alkyl-SO₃H or a salt thereof, or wherein R is C₁₋₆alkyl-CO₂H or a salt thereof, or wherein R is C₁₋₆alkyl-PO₃H₂ or a salt thereof. All Ar² can be

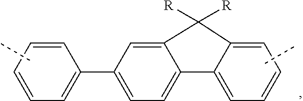

wherein R is C₁₋₆alkyl-SO₃H or a salt thereof, or wherein R is C₁₋₆alkyl-CO₂H or a salt thereof, or wherein R is C₁₋₆alkyl-PO₃H₂ or a salt thereof. All Ar² can be

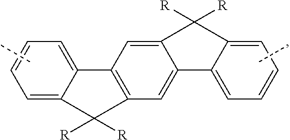

wherein R is C₁₋₆alkyl-SO₃H or a salt thereof, or wherein R is C₁₋₆alkyl-CO₂H or a salt thereof, or wherein R is C₁₋₆alkyl-PO₃H₂ or a salt thereof. All Ar² can be

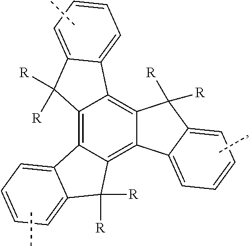

wherein R is C₁₋₆alkyl-SO₃H or a salt thereof, or wherein R is C₁₋₆alkyl-CO₂H or a salt thereof, or wherein R is C₁₋₆alkyl-PO₃H₂ or a salt thereof.

Each geminal pair of R³ and R⁴ can independently be identical or different. For each geminal pair of R³ and R⁴, R³ and R⁴ can independently be identical or different from each other. At least one R³ can be C₁₋₆ alkyl. At least one R³ can be C₁₋₆ haloalkyl. At least one R³ can be C₃₋₁₀ cycloalkyl. At least one R³ can be C₃₋₁₀ heterocycloalkyl. At least one R³ can be aryl. At least one R³ can be heteroaryl. At least one R⁴ can be C₁₋₆ alkyl. At least one R⁴ can be C₁₋₆ haloalkyl. At least one R⁴ can be C₃₋₁₀ cycloalkyl. At least one R⁴ can be C₃₋₁₀ heterocycloalkyl. At least one R⁴ can be aryl. At least one R⁴ can be heteroaryl. All R³ can be C₁₋₆ alkyl. All R³ can be C₁₋₆ haloalkyl. All R³ can be C₃₋₁₀ cycloalkyl. All R³ can be C₃₋₁₀ heterocycloalkyl. All R³ can be aryl. All R³ can be heteroaryl. All R⁴ can be C₁₋₆ alkyl. All R⁴ can be C₁₋₆ haloalkyl. All R⁴ can be C₃₋₁₀ cycloalkyl. All R⁴ can be C₃₋₁₀ heterocycloalkyl. All R⁴ can be aryl. All R⁴ can be heteroaryl. At least one geminal pair of R³ and R⁴, together with the carbon atom to which they are attached, can form a carbocycle. All geminal pairs of R³ and R⁴, together with the carbon atom to which they are attached, can form carbocycles. At least one geminal pair of R³ and R⁴, together with the carbon atom to which they are attached, can form a heterocycle. All geminal pairs of R³ and R⁴, together with the carbon atom to which they are attached, can form heterocycles.

The disclosure also provides a polymer comprising a plurality of repeat units of formula (1), optionally a plurality of repeat units of the formula (II), and a plurality of repeat units of formula (III):

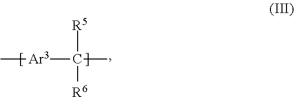

wherein each Ar³ is independently a unit comprising two or more aromatic rings and Ar³ does not contain a cross-linking group selected from a terminal C—C double bond, an internal C—C double bond that is not part of an aryl ring, a C—C triple bond, a ketone, and a combination thereof; and each R⁵ and R⁶ is independently selected from C₁₋₆ alkyl, C₁₋₆ haloalkyl, C₃₋₁₀ cycloalkyl, C₃₋₁₀ heterocycloalkyl, aryl, and heteroaryl, each optionally having one or more substituents selected from halo, alkyl, aryl, amino, and quaternary ammonium, or R⁵ and R⁶, together with the carbon atom to which they are attached, form a carbocycle or heterocycle.

Ar³ is not particularly limited, provided it contains two or more aromatic rings and does not contain a cross-linking group. For instance, Ar³ can include, but is not limited to,

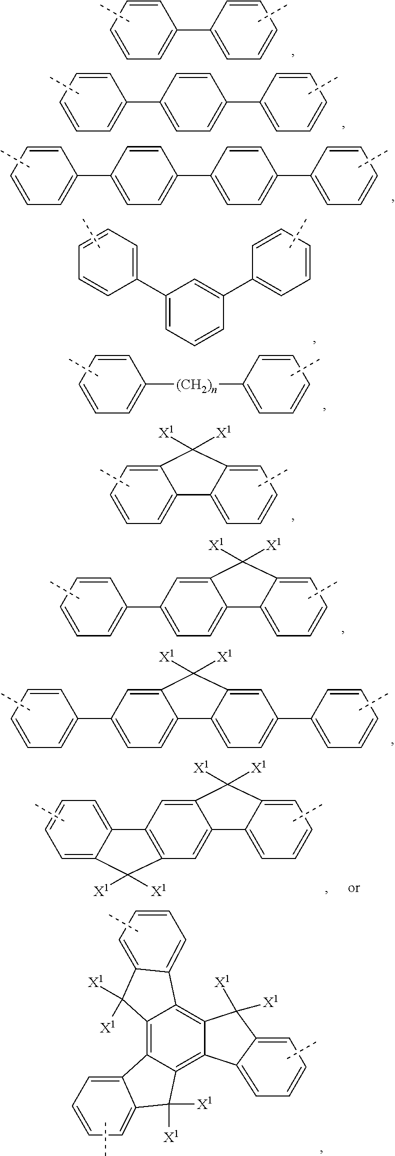

wherein each n is independently selected from 1, 2, 3, 4, 5, and 6, and each X¹ is independently selected from H and C₁₋₆ alkyl. Without intending to be bound by theory, repeat units of formula (III) do not have functional groups that are readily cross-linkable by chemical or thermal means described herein, and incorporating repeat units of formula (III) into the polymer can reduce the extent to which the polymer can be cross-linked, providing a means to tune mechanical properties of the cross-linked polymer.

Each geminal pair of R⁵ and R⁶ can independently be identical or different. For each geminal pair of R⁵ and R⁶, R⁵ and R⁶ can independently be identical or different from each other. At least one R⁵ can be C₁₋₆ alkyl. At least one R⁵ can be C₁₋₆ haloalkyl. At least one R⁵ can be C₃₋₁₀ cycloalkyl. At least one R⁵ can be C₃₋₁₀ heterocycloalkyl. At least one R⁵ can be aryl. At least one R⁵ can be heteroaryl. At least one R⁶ can be C₁₋₆ alkyl. At least one R⁶ can be C₁₋₆ haloalkyl. At least one R⁶ can be C₃₋₁₀ cycloalkyl. At least one R⁶ can be C₃₋₁₀ heterocycloalkyl. At least one R⁶ can be aryl. At least one R⁶ can be heteroaryl. All R⁵ can be C₁₋₆ alkyl. All R⁵ can be C₁₋₆ haloalkyl. All R⁵ can be C₃₋₁₀ cycloalkyl. All R⁵ can be C₃₋₁₀ heterocycloalkyl. All R⁵ can be aryl. All R⁵ can be heteroaryl. All R⁶ can be C₁₋₆ alkyl. All R⁶ can be C₁₋₆ haloalkyl. All R⁶ can be C₃₋₁₀ cycloalkyl. All R⁶ can be C₃₋₁₀ heterocycloalkyl. All R⁶ can be aryl. All R⁶ can be heteroaryl. At least one geminal pair of R⁵ and R⁶, together with the carbon atom to which they are attached, can form a carbocycle. All geminal pairs of R⁵ and R⁶, together with the carbon atom to which they are attached, can form carbocycles. At least one geminal pair of R⁵ and R⁶ together with the carbon atom to which they are attached can form a heterocycle. All geminal pairs of R⁵ and R⁶ together with the carbon atom to which they are attached can form heterocycles.

Polymers of the disclosure can consist of a plurality of repeat units of formula (1). A polymer of this type can be used, for instance, as an ionomer in a membrane electrode assembly.

Polymers of the disclosure can comprise a plurality of repeat units of formula (1) and a plurality of repeat units of formula (II). Such polymers can have a ratio of the number of repeat units of formula (1) to the number of repeat units of formula (III) (i.e., a molar ratio) in a range of from about 20:1 to about 1:20, or about 10:1 to about 1:10, or about 5:1 to about 1:5, or about 3:1 to about 1:3, or about 2:1 to about 1:2, or about 1:1. A polymer of this type can be used, for instance, as an ionomer in a membrane electrode assembly or as a component of a proton exchange membrane or an anion exchange membrane.

Polymers of the disclosure can comprise a plurality of repeat units of formula (1) and a plurality of repeat units of formula (III). Such polymers can have a ratio of the number of repeat units of formula (1) to the number of repeat units of formula (III) (i.e., a molar ratio) in a range of from about 20:1 to about 1:20, or about 10:1 to about 1:10, or about 5:1 to about 1:5, or about 3:1 to about 1:3, or about 2:1 to about 1:2, or about 1:1. A polymer of this type can be used, for instance, as an ionomer in a membrane electrode assembly or as a component of a proton exchange membrane, an anion exchange membrane, or a gas separation membrane.

Polymers of the disclosure can comprise a plurality of repeat units of formula (1), a plurality of repeat units of formula (II), and a plurality of repeat units of formula (III). In such polymers, the repeat units of formula (1), formula (II), and formula (III) can each independently be provided in a range of from about 1 mol % to about 98 mol %, or about 5 mol % to about 90 mol %, or about 10 mol % to about 80 mol %, or about 15 mol % to about 70 mol %, or about 20 mol % to about 60 mol %, or about 25 mol % to about 50 mol %, or about 30 mol % to about 40 mol %, based on the total moles of repeat units of formula (1), formula (II), and formula (III). A polymer of this type can be used, for instance, as a component of a proton exchange membrane or an anion exchange membrane.

The disclosure also provides a polymer comprising a plurality of repeat units of formula (IV):

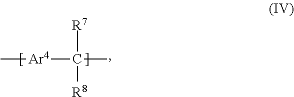

wherein each Ar⁴ is independently a unit having two or more aromatic rings and at least one substituent selected from —SO₃H, —CO₂H, —PO₃H₂, amine, quaternary ammonium, a salt of any of the foregoing, and a combination of any of the foregoing, and Ar⁴ does not contain a terminal C—C double bond, an internal C—C double bond that is not part of an aryl ring, a C—C triple bond, or a ketone; and each R⁷ and R⁸ is independently selected from C₁₋₆ alkyl, C₁₋₆ haloalkyl, C₃₋₁₀ cycloalkyl, C₃₋₁₀ heterocycloalkyl, aryl, and heteroaryl, each optionally substituted with one or more substituents selected from halo, alkyl, aryl, and amide, or R⁷ and R⁸, together with the carbon atom to which they are attached form a carbocycle or heterocycle, and wherein at least one of R⁷ and R⁸ contains an amide group or at least one pair of R⁷ and R⁸, together with the carbon atom to which they are attached, forms a carbocycle or heterocycle that contains an amide group. Polymers of this type can be cross-linked by forming covalent bonds between amide groups, for instance by introducing a cross-linker molecule having two or more functional groups that can react with an amide nitrogen to form a covalent bond. A polymer of this type can be used, for instance, as a component of a proton exchange membrane or an anion exchange membrane.

Polymers of the disclosure comprising a plurality of repeat units of formula (IV) can comprise Ar⁴ units containing one or more of —SO₃H, —CO₂H, —PO₃H₂, amine, quaternary ammonium, and salts thereof. At least one Ar⁴ can comprise —SO₃H, —CO₂H, or —PO₃H₂, amine, or quaternary ammonium. At least one Ar⁴ can comprise —SO₃H. At least one Ar⁴ can comprise —CO₂H. At least one Ar⁴ can comprise —PO₃H₂. At least one Ar⁴ can comprise amine. At least one Ar⁴ can comprise quaternary ammonium. All Ar⁴ can comprise —SO₃H. All Ar⁴ can comprise —CO₂H. All Ar⁴ can comprise —PO₃H₂. All Ar⁴ can comprise amine. All Ar⁴ can comprise quaternary ammonium. Ar⁴ can be, but is not limited to,

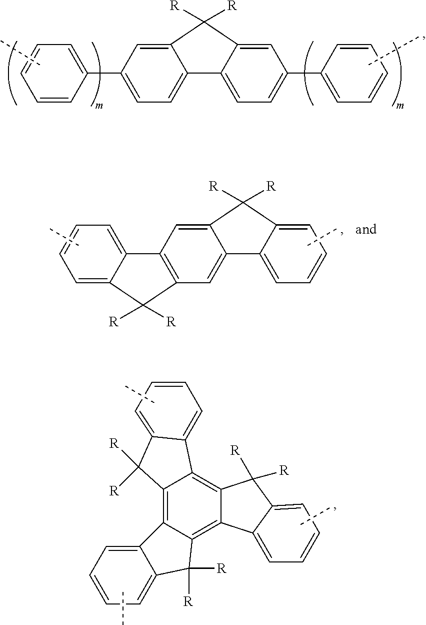

wherein each R is independently selected from C₁₋₆alkyl-SO₃H, C₁₋₆alkyl-CO₂H, C₁₋₆alkyl-PO₃H₂, (CH₂)₁₋₆NH₂, (CH₂)₁₋₆NHCH₃, (CH₂)₁₋₆N(CH₃)₂, (CH₂)₁₋₆N(CH₃)₃⁺OH⁻,

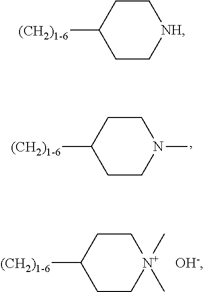

and salts thereof; each m is independently 0 or 1; and the dotted lines indicate bonds between a carbon of the aromatic ring from which the dotted line extends and the carbon on a neighboring

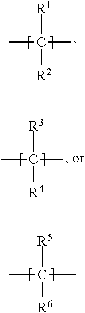

monomer unit, provided that when m is 0, the dotted lines are considered to extend from the two aromatic rings (i.e.,

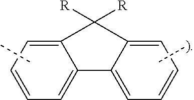

At least one Ar⁴ can be

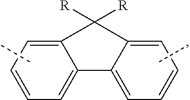

wherein R is C₁₋₆alkyl-SO₃H or a salt thereof, or wherein R is C₁₋₆alkyl-CO₂H or a salt thereof, or wherein R is C₁₋₆alkyl-PO₃H₂ or a salt thereof, or wherein R is (CH₂)₁₋₆NH₂ or a salt thereof, or wherein R is (CH₂)₁₋₆NHCH₃ or a salt thereof, or wherein R is (CH₂)₁₋₆N(CH₃)₂ or a salt thereof, or wherein R is (CH₂)₁₋₆N(CH₃)₃+OH- or a salt thereof, or wherein R is

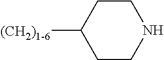

or a salt thereof, or wherein R is

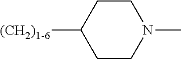

or a salt thereof, or wherein R is

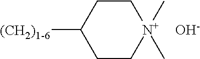

or a salt thereof. At least one Ar⁴ can be

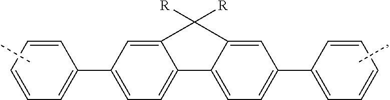

wherein R is C₁₋₆alkyl-SO₃H or a salt thereof, or wherein R is C₁₋₆alkyl-CO₂H or a salt thereof, or wherein R is C₁₋₆alkyl-PO₃H₂ or a salt thereof, or wherein R is (CH₂)₁₋₆NH₂ or a salt thereof, or wherein R is (CH₂)₁₋₆NHCH₃ or a salt thereof, or wherein R is (CH₂)₁₋₆N(CH₃)₂ or a salt thereof, or wherein R is (CH₂)₁₋₆N(CH₃)₃⁺OH⁻ or a salt thereof, or wherein R is

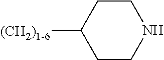

or a salt thereof, or wherein R is

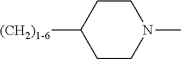

or a salt thereof, or wherein R is

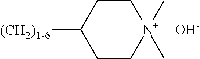

or a salt thereof. At least one Ar⁴ can be

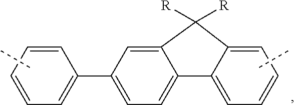

wherein R is C₁₋₆alkyl-SO₃H or a salt thereof, or wherein R is C₁₋₆alkyl-CO₂H or a salt thereof, or wherein R is C₁₋₆alkyl-PO₃H₂ or a salt thereof, or wherein R is (CH₂)₁₋₆NH₂ or a salt thereof, or wherein R is (CH₂)₁₋₆NHCH₃ or a salt thereof, or wherein R is (CH₂)₁₋₆N(CH₃)₂ or a salt thereof, or wherein R is (CH₂)₁₋₆N(CH₃)₃⁺OH⁻ or a salt thereof, or wherein R is

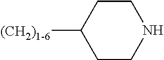

or a salt thereof, or wherein R is

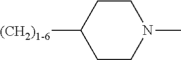

or a salt thereof, or wherein R is

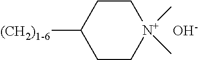

or a salt thereof. At least one Ar⁴ can be

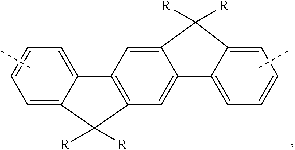

wherein R is C₁₋₆alkyl-SO₃H or a salt thereof, or wherein R is C₁₋₆alkyl-CO₂H or a salt thereof, or wherein R is C₁₋₆alkyl-PO₃H₂ or a salt thereof, or wherein R is (CH₂)₁₋₆NH₂ or a salt thereof, or wherein R is (CH₂)₁₋₆NHCH₃ or a salt thereof, or wherein R is (CH₂)₁₋₆N(CH₃)₂ or a salt thereof, or wherein R is (CH₂)₁₋₆N(CH₃)₃⁺OH⁻ or a salt thereof, or wherein R is

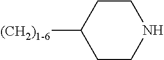

or a salt thereof, or wherein R is

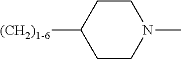

or a salt thereof, or wherein R is

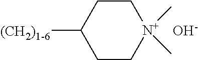

or a salt thereof. At least one Ar⁴ can be

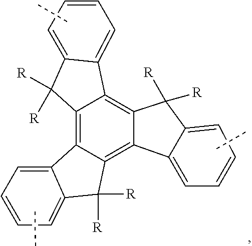

wherein R is C₁₋₆alkyl-SO₃H or a salt thereof, or wherein R is C₁₋₆alkyl-CO₂H or a salt thereof, or wherein R is C₁₋₆alkyl-PO₃H₂ or a salt thereof, or wherein R is (CH₂)₁₋₆NH₂ or a salt thereof, or wherein R is (CH₂)₁₋₆NHCH₃ or a salt thereof, or wherein R is (CH₂)₁₋₆N(CH₃)₂ or a salt thereof, or wherein R is (CH₂)₁₋₆N(CH₃)₃+OH- or a salt thereof, or wherein R is

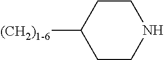

or a salt thereof, or wherein R is

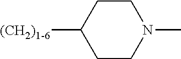

or a salt thereof, or wherein R is

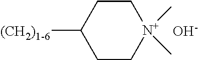

or a salt thereof. All Ar⁴ can be

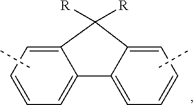

wherein R is C₁₋₆alkyl-SO₃H or a salt thereof, or wherein R is C₁₋₆alkyl-CO₂H or a salt thereof, or wherein R is C₁₋₆alkyl-PO₃H₂ or a salt thereof, or wherein R is (CH₂)₁₋₆NH₂ or a salt thereof, or wherein R is (CH₂)₁₋₆NHCH₃ or a salt thereof, or wherein R is (CH₂)₁₋₆N(CH₃)₂ or a salt thereof, or wherein R is (CH₂)₁₋₆N(CH₃)₃⁺OH⁻ or a salt thereof, or wherein R is

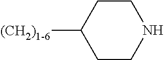

or a salt thereof, or wherein R is

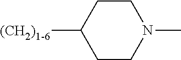

or a salt thereof, or wherein R is

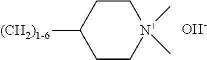

or a salt thereof. All Ar⁴ can be

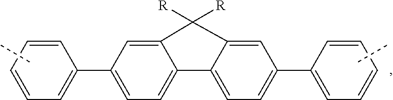

wherein R is C₁₋₆alkyl-SO₃H or a salt thereof, or wherein R is C₁₋₆alkyl-CO₂H or a salt thereof, or wherein R is C₁₋₆alkyl-PO₃H₂ or a salt thereof, or wherein R is (CH₂)₁₋₆NH₂ or a salt thereof, or wherein R is (CH₂)₁₋₆NHCH₃ or a salt thereof, or wherein R is (CH₂)₁₋₆N(CH₃)₂ or a salt thereof, or wherein R is (CH₂)₁₋₆N(CH₃)₃+OH- or a salt thereof, or wherein R is

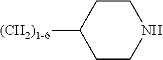

or a salt thereof, or wherein R is

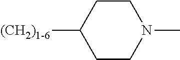

or a salt thereof, or wherein R is

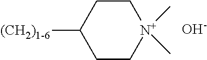

or a salt thereof. All Ar⁴ can be

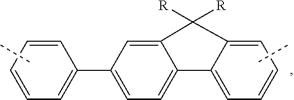

wherein R is C₁₋₆alkyl-SO₃H or a salt thereof, or wherein R is C₁₋₆alkyl-CO₂H or a salt thereof, or wherein R is C₁₋₆alkyl-PO₃H₂ or a salt thereof, or wherein R is (CH₂)₁₋₆NH₂ or a salt thereof, or wherein R is (CH₂)₁₋₆NHCH₃ or a salt thereof, or wherein R is (CH₂)₁₋₆N(CH₃)₂ or a salt thereof, or wherein R is (CH₂)₁₋₆N(CH₃)₃+OH- or a salt thereof, or wherein R is

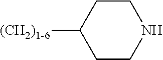

or a salt thereof, or wherein R is

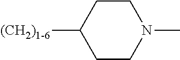

or a salt thereof, or wherein R is

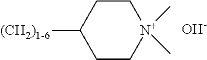

or a salt thereof. All Ar⁴ can be

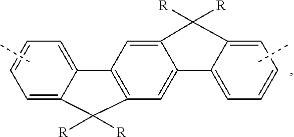

wherein R is C₁₋₆alkyl-SO₃H or a salt thereof, or wherein R is C₁₋₆alkyl-CO₂H or a salt thereof, or wherein R is C₁₋₆alkyl-PO₃H₂ or a salt thereof, or wherein R is (CH₂)₁₋₆NH₂ or a salt thereof, or wherein R is (CH₂)₁₋₆NHCH₃ or a salt thereof, or wherein R is (CH₂)₁₋₆N(CH₃)₂ or a salt thereof, or wherein R is (CH₂)₁₋₆N(CH₃)₃⁺OH⁻ or a salt thereof, or wherein R is

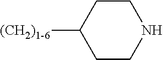

or a salt thereof, or wherein R is

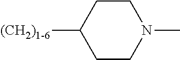

or a salt thereof, or wherein R is

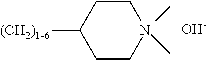

or a salt thereof. All Ar⁴ can be

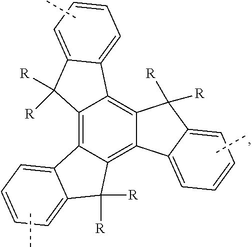

wherein R is C₁₋₆alkyl-SO₃H or a salt thereof, or wherein R is C₁₋₆alkyl-CO₂H or a salt thereof, or wherein R is C₁₋₆alkyl-PO₃H₂ or a salt thereof, or wherein R is (CH₂)₁₋₆NH₂ or a salt thereof, or wherein R is (CH₂)₁₋₆NHCH₃ or a salt thereof, or wherein R is (CH₂)₁₋₆N(CH₃)₂ or a salt thereof, or wherein R is (CH₂)₁₋₆N(CH₃)₃⁺OH⁻ or a salt thereof, or wherein R is

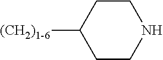

or a salt thereof, or wherein R is

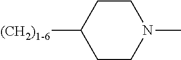

or a salt thereof, or wherein R is

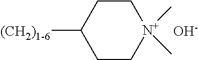

or a salt thereof. A polymer of this type can be used, for instance, as a component of a proton exchange membrane or an anion exchange membrane.

Each geminal pair of R⁷ and R⁸ can independently be identical or different. For each geminal pair of R⁷ and R⁸, R⁷ and R⁸ can independently be identical or different from each other. At least one R⁷ can be C₁₋₆ alkyl. At least one R⁷ can be C₁₋₆ haloalkyl. At least one R⁷ can be C₃₋₁₀ cycloalkyl. At least one R⁷ can be C₃₋₁₀ heterocycloalkyl. At least one R⁷ can be aryl. At least one R⁷ can be heteroaryl. At least one R⁸ can be C₁₋₆ alkyl. At least one R⁸ can be C₁₋₆ haloalkyl. At least one R⁸ can be C₃₋₁₀ cycloalkyl. At least one R⁸ can be C₃₋₁₀ heterocycloalkyl. At least one R⁸ can be aryl. At least one R⁸ can be heteroaryl. At least one geminal pair of R⁷ and R⁸ can be CF₃ and phenyl. At least one geminal pair of R⁷ and R⁸ can be CF₃ and methyl.

At least one geminal pair of R⁷ and R⁸, together with the carbon atom to which they are attached, can form a carbocycle. At least one geminal pair of R⁷ and R⁸, together with the carbon atom to which they are attached, can form a heterocycle. At least one geminal pair of R⁷ and R⁸ together with the carbon atom to which they are attached can form a heterocycle selected from

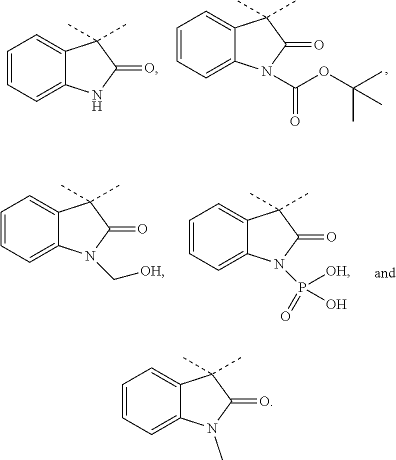

All geminal pairs of R⁷ and R⁸ together with the carbon atom to which they are attached can form heterocycles selected from

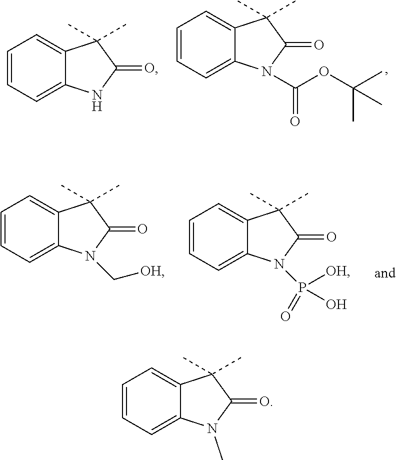

The disclosure also provides a polymer comprising a plurality of repeat units of formula (IV) and a plurality of repeat units of formula (V):

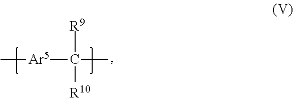

wherein each Ar⁵ is independently a unit having two or more aromatic rings, wherein Ar⁵ does not contain a cross-linkable group selected from a terminal C═C double bond, an internal C═C double bond that is not part of an aryl ring, and a C—C triple bond, and each R⁹ and R¹⁰ is independently selected from C₁₋₆ alkyl, C₁₋₆ haloalkyl, C₃₋₁₀ cycloalkyl, C₃₋₁₀ heterocycloalkyl, aryl, and heteroaryl, each optionally having one or more substituents selected from halo, alkyl, aryl, and amide, or R⁹ and R¹⁰, together with the carbon atom to which they are attached, form a carbocycle or heterocycle, wherein at least one pair of R⁹ and R¹⁰, together with the carbon atom to which they are attached, form a carbocycle or heterocycle and the carbocycle or heterocycle has an amide substituent.

Ar⁵ is not particularly limited, provided it contains two or more aromatic rings and does not contain a cross-linking group. For instance, Ar⁵ can include, but is not limited to,

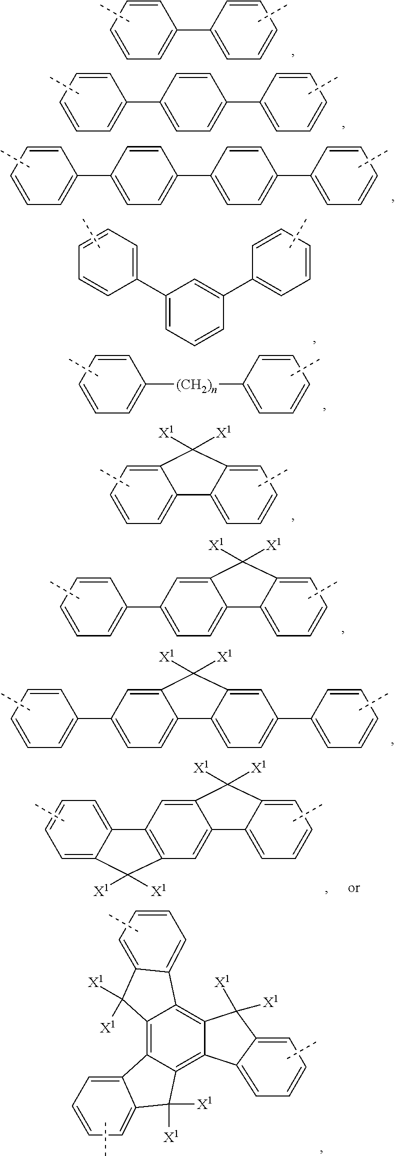

wherein each n is independently selected from 1, 2, 3, 4, 5, and 6, and each X¹ is independently selected from H and C₁₋₆ alkyl.

Each geminal pair of R⁹ and R¹⁰ can independently be identical or different. For each geminal pair of R⁹ and R¹⁰, R⁹ and R¹⁰ can independently be identical or different from each other. At least one R⁹ can be C₁₋₆ alkyl. At least one R⁹ can be C₁₋₆ haloalkyl. At least one R⁹ can be C₃₋₁₀ cycloalkyl. At least one R⁹ can be C₃₋₁₀ heterocycloalkyl. At least one R⁹ can be aryl. At least one R⁹ can be heteroaryl. At least one R¹⁰ can be C₁₋₆ alkyl. At least one R¹⁰ can be C₁₋₆ haloalkyl. At least one R¹⁰ can be C₃₋₁₀ cycloalkyl. At least one R¹⁰ can be C₃₋₁₀ heterocycloalkyl. At least one R¹⁰ can be aryl. At least one R¹⁰ can be heteroaryl. All R⁹ can be C₁₋₆ alkyl. All R⁹ can be C₁₋₆ haloalkyl. All R⁹ can be C₃₋₁₀ cycloalkyl. All R⁹ can be C₃₋₁₀ heterocycloalkyl. All R⁹ can be aryl. All R⁹ can be heteroaryl. All R¹⁰ can be C₁₋₆ alkyl. All R¹⁰ can be C₁₋₆ haloalkyl. All R¹⁰ can be C₃₋₁₀ cycloalkyl. All R¹⁰ can be C₃₋₁₀ heterocycloalkyl. All R¹⁰ can be aryl. All R¹⁰ can be heteroaryl. At least one geminal pair of R⁹ and R¹⁰, together with the carbon atom to which they are attached, can form a carbocycle. All geminal pairs of R⁹ and R¹⁰, together with the carbon atom to which they are attached, can form carbocycles. At least one geminal pair of R⁹ and R¹⁰ together with the carbon atom to which they are attached can form a heterocycle. All geminal pairs of R⁹ and R¹⁰ together with the carbon atom to which they are attached can form heterocycles. At least one geminal pair of R⁹ and R¹⁰ can be CF₃ and phenyl. At least one geminal pair of R⁹ and R¹⁰ can be CF₃ and methyl.

At least one geminal pair of R⁹ and R¹⁰, together with the carbon atom to which they are attached, can form a carbocycle. At least one geminal pair of R⁹ and R¹⁰, together with the carbon atom to which they are attached, can form a heterocycle. At least one geminal pair of R⁹ and R¹⁰ together with the carbon atom to which they are attached can form a heterocycle containing an amide group, for instance,

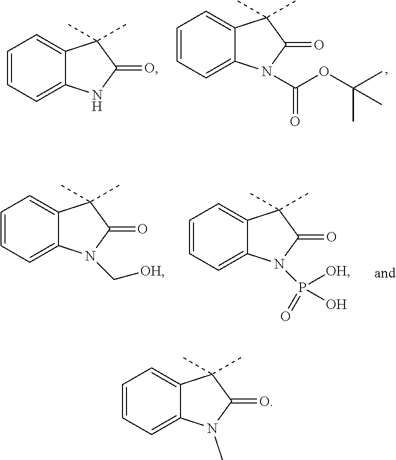

All geminal pairs of R⁹ and R¹⁰ together with the carbon atom to which they are attached can form heterocycle containing an amide group, for instance,

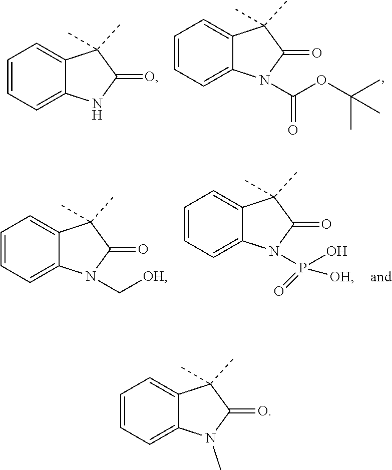

### Polymer Synthesis

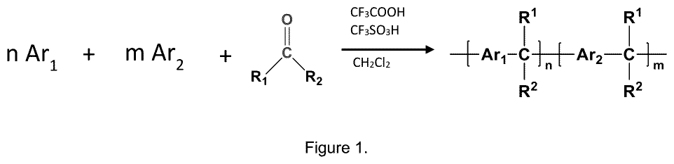

Polymers of the disclosure can be prepared by polymerizing suitable monomers by a polyhydroxyalkylation process, as described herein. In general, one or more aromatic group-containing monomers of the disclosure and one or more ketone-containing monomers of the disclosure can be dispersed in a solvent, and the resulting reaction mixture can be treated with a superacid catalyst under time and temperature conditions as described herein, followed by precipitation, filtration, washing, and drying steps to provide the polymer. FIG. 1 shows a generic reaction scheme for a polymer having repeat units of formulas (I) and (II).

The polyhydroxyalkylation reaction can be carried out in the presence of a superacid catalyst. In general, a superacid is an acid having an acidity greater than that of sulfuric acid. The superacid catalyst can include, but is not limited to, trifluoromethanesulfonic acid, fluorosulfuric acid, methanesulfonic acid, trifluoroacetic acid, and mixtures thereof.

Polymers of the disclosure contain one or more cross-linkable functional groups. Cross-linkable groups can include, but are not limited to, a terminal C═C double bond, an internal C═C double bond that is not part of an aryl ring, a C—C triple bond, a ketone, an amide, and combinations thereof. Cross-linkable groups can be incorporated in polymers of the disclosure by including one or more monomers that contains a cross-linkable group in the polymerization. Such cross-linkable groups are generally stable under the polymerization conditions described herein, such that the cross-linkable groups are generally present in the resulting polymers. Cross-linkable groups may be present one or more aromatic group-containing monomers, one or more ketone-containing monomers, or a combination thereof. Additionally or alternatively, cross-linkable groups can be incorporated in polymers of the disclosure by performing a post-polymerization reaction to install a cross-linkable group. For instance, polymers comprising fluorene units can be reacted with an allyl halide to add cross-linkable allyl groups at the 9-position.

Polymers of the disclosure are free or substantially free of fluorine-containing substituents.

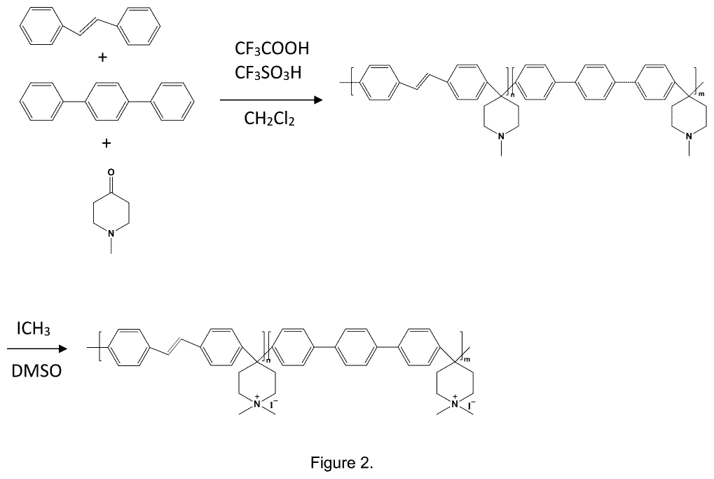

Polymers of the disclosure that contain a plurality of functional groups that are suitable for anion exchange (including, but not limited to, quaternary ammonium) or proton exchange (including, but not limited to, sulfonic, carboxylic, or phosphonic acid) can be prepared by including one or more monomers that contain the anion exchange or proton exchange group in the polymerization. In particular, described herein are the synthesis of a sulfonic acid-containing monomer, 4,4′-(9H-fluorene-9,9-diyl)bis(butane-1-sulfonic acid, bis(tetramethylammonium) salt) and its use in polymerizations to provide polymers according to the disclosure containing a plurality of proton exchange groups. Other polymers of the disclosure that contain a plurality of functional groups that are suitable for anion exchange or proton exchange can be prepared by including one or more monomers that contain a functional group that is a precursor to an anion exchange or proton exchange group, followed by a post-polymerization reaction to convert the precursor group to an anion exchange or proton exchange group. For instance, a monomer containing a tertiary amine can be included in the polymerization, to provide a polymer containing tertiary amine groups, and a plurality of the tertiary amine groups can be converted to quaternary ammonium groups by a simple post-polymerization reaction. An illustration of a reaction scheme to provide a polymer comprising quaternary ammonium groups is shown in FIG. 2. As illustrated in FIG. 2, stilbene, p-terphenyl, and N-methylpiperidone can be polymerized via superacid-catalyzed polyhydroxyalkylation to provide a polymer having tertiary amine groups, followed by reaction with iodomethane to provide a polymer having quaternary ammonium groups, which are suitable for anion exchange.

The aromatic group-containing monomers are not particularly limited and can generally correspond to aromatic groups described above for the repeat units of formula (1), formula (II), formula (III), formula (IV), and formula (V). Aromatic group-containing monomers can be selected from Ar^{1′}, Ar^{2′}, Ar^{3′}, Ar^{4′}, Ar^{5′} and a combination thereof.

Ar^{1′} is a monomer comprising two or more aromatic rings and at least one cross-linkable group selected from a terminal C═C double bond, an internal C═C double bond that is not part of an aryl ring, a C—C triple bond, a ketone, and a combination thereof. Ar^{1′} can comprise an internal C═C double bond that is not part of an aryl ring. Ar^{1′} can comprise a terminal C═C double bond. Ar^{1′} can comprise a C—C triple bond. Ar^{1′} can comprise a ketone group. Ar^{1′} monomers of the disclosure can be selected from, but are not limited to,

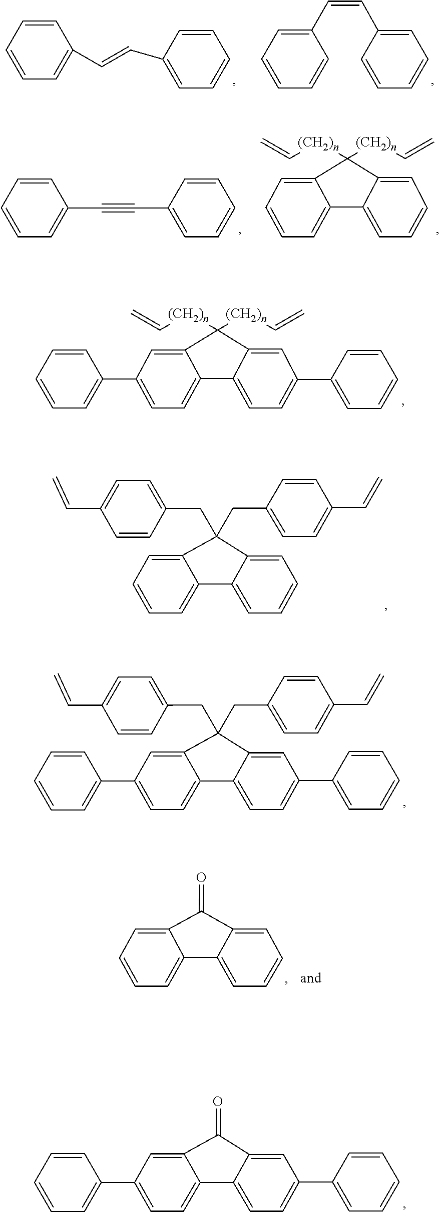

wherein each n is independently selected from 1, 2, 3, 4, 5, and 6.

Ar^{2′} is a monomer comprising two or more aromatic rings and at least one substituent selected from —SO₃H, —CO₂H, —PO₃H₂, a salt of any of the foregoing, and a combination of any of the foregoing. At least one Ar^{2′} can comprise —SO₃H, —CO₂H, or —PO₃H₂. At least one Ar^{2′} can comprise —SO₃H. At least one Ar^{2′} can comprise —CO₂H. At least one Ar^{2′} can comprise —PO₃H₂. All Ar^{2′} can comprise —SO₃H. All Ar^{2′} can comprise —CO₂H. All Ar^{2′} can comprise —PO₃H₂. Ar^{2′} can be selected from, but is not limited to,

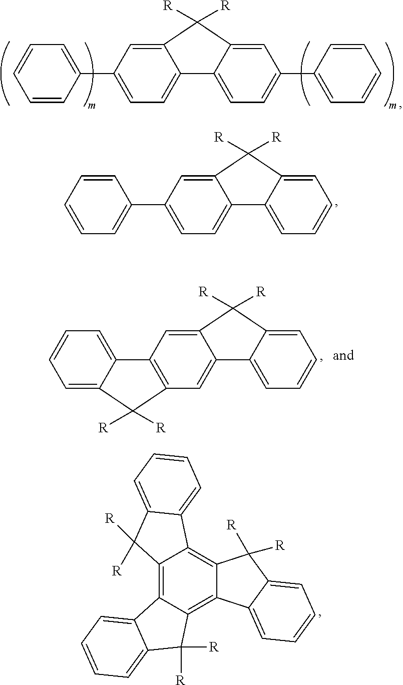

wherein each R is independently selected from C₁₋₆alkyl-SO₃H, C₁₋₆alkyl-CO₂H, C₁₋₆alkyl-PO₃H₂, and salts thereof, and where each m is independently 0 or 1. Ar^{2′} can be

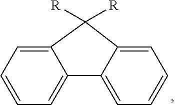

wherein R is C₁₋₆alkyl-SO₃H or a salt thereof, or wherein R is C₁₋₆alkyl-CO₂H or a salt thereof, or wherein R is C₁₋₆alkyl-PO₃H₂ or a salt thereof. Ar^{2′} can be

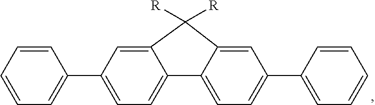

wherein R is C₁₋₆alkyl-SO₃H or a salt thereof, or wherein R is C₁₋₆alkyl-CO₂H or a salt thereof, or wherein R is C₁₋₆alkyl-PO₃H₂ or a salt thereof. Ar^{2′} can be

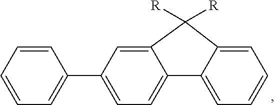

wherein R is C₁₋₆alkyl-SO₃H or a salt thereof, or wherein R is C₁₋₆alkyl-CO₂H or a salt thereof, or wherein R is C₁₋₆alkyl-PO₃H₂ or a salt thereof. Ar^{2′} can be

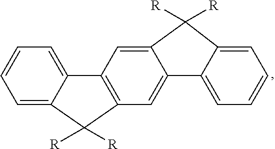

wherein R is C₁₋₆alkyl-SO₃H or a salt thereof, or wherein R is C₁₋₆alkyl-CO₂H or a salt thereof, or wherein R is C₁₋₆alkyl-PO₃H₂ or a salt thereof. Ar^{2′} can be

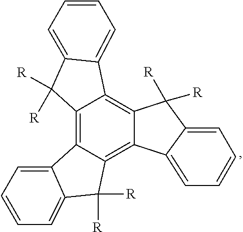

wherein R is C₁₋₆alkyl-SO₃H or a salt thereof, or wherein R is C₁₋₆alkyl-CO₂H or a salt thereof, or wherein R is C₁₋₆alkyl-PO₃H₂ or a salt thereof.

Ar^{3′} is a monomer comprising two or more aromatic rings but not containing any of a terminal C═C double bond, an internal C═C double bond that is not part of an aryl ring, a C—C triple bond, or a ketone. Ar^{3′} monomers of the disclosure can be selected from, but are not limited to,

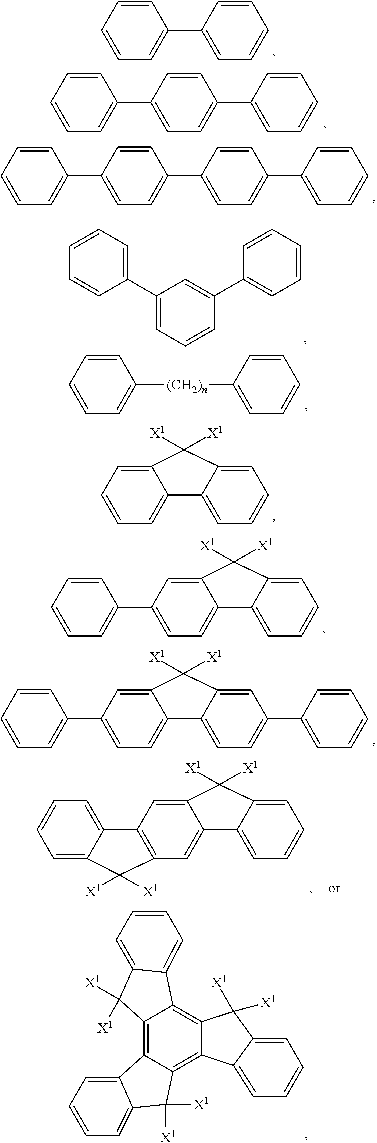

wherein each n is independently selected from 1, 2, 3, 4, 5, and 6, and each X¹ is independently selected from H and C₁₋₆ alkyl.

Ar^{4′} is a monomer comprising two or more aromatic rings and at least one substituent selected from —SO₃H, —CO₂H, —PO₃H₂, amine, quaternary ammonium, a salt of any of the foregoing, and a combination of any of the foregoing, provided that Ar^{4′} does not contain a terminal C═C double bond, an internal C═C double bond that is not part of an aryl ring, a C—C triple bond, or a ketone. At least one Ar^{4′} can comprise —SO₃H, —CO₂H, —PO₃H₂, amine, or quaternary ammonium. At least one Ar^{4′} can comprise —SO₃H. At least one Ar^{4′} can comprise —CO₂H. At least one Ar^{4′} can comprise —PO₃H₂. At least one Ar^{4′} can comprise an amine. At least one Ar^{4′} can comprise quaternary ammonium. All Ar^{4′} can comprise —SO₃H. All Ar^{4′} can comprise —CO₂H. All Ar^{4′} can comprise —PO₃H₂. All Ar^{4′} can comprise an amine. All Ar^{4′} can comprise quaternary ammonium. Ar^{4′} can be selected from, but is not limited to,

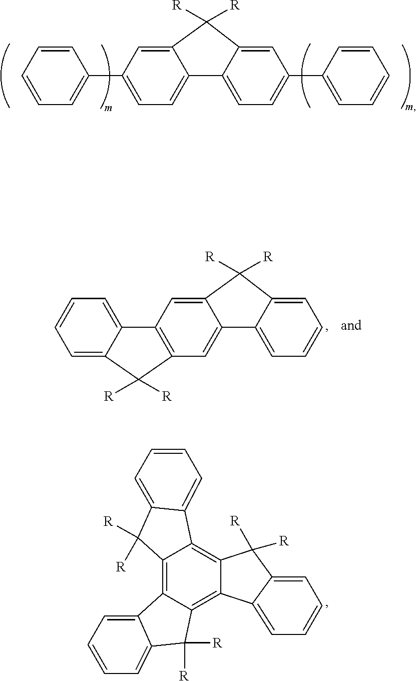

wherein each R is independently selected from C₁₋₆alkyl-SO₃H, C₁₋₆alkyl-CO₂H, C₁₋₆alkyl-PO₃H₂, (CH₂)₁₋₆NH₂, (CH₂)₁₋₆NHCH₃, (CH₂)₁₋₆N(CH₃)₂, (CH₂)₁₋₆N(CH₃)₃⁺OH⁻,

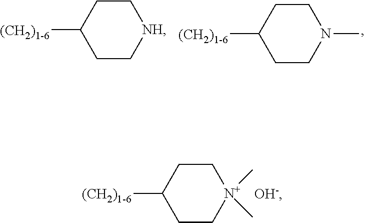

and salts thereof, and where each m is independently 0 or 1. Ar^{4′} can be

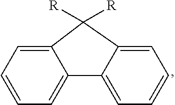

wherein R is C₁₋₆alkyl-SO₃H or a salt thereof, or wherein R is C₁₋₆alkyl-CO₂H or a salt thereof, or wherein R is C₁₋₆alkyl-PO₃H₂ or a salt thereof, or wherein R is (CH₂)₁₋₆NH₂ or a salt thereof, or wherein R is (CH₂)₁₋₆NHCH₃ or a salt thereof, or wherein R is (CH₂)₁₋₆N(CH₃)₂ or a salt thereof, or wherein R is (CH₂)₁₋₆N(CH₃)₃+OH- or a salt thereof, or wherein R is

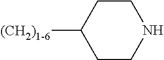

or a salt thereof, or wherein R is

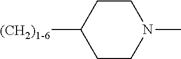

or a salt thereof, or wherein R is

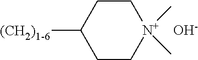

or a salt thereof. Ar^{4′} can be

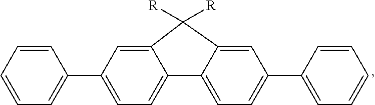

wherein R is C₁₋₆alkyl-SO₃H or a salt thereof, or wherein R is C₁₋₆alkyl-CO₂H or a salt thereof, or wherein R is C₁₋₆alkyl-PO₃H₂ or a salt thereof, or wherein R is (CH₂)₁₋₆NH₂ or a salt thereof, or wherein R is (CH₂)₁₋₆NHCH₃ or a salt thereof, or wherein R is (CH₂)₁₋₆N(CH₃)₂ or a salt thereof, or wherein R is (CH₂)₁₋₆N(CH₃)₃+OH- or a salt thereof, or wherein R is

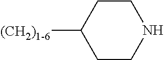

or a salt thereof, or wherein R is

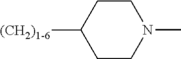

or a salt thereof, or wherein R is

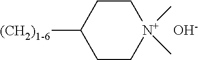

or a salt thereof. Ar^{4′} can be

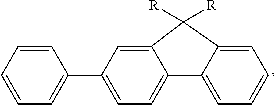

wherein R is C₁₋₆alkyl-SO₃H or a salt thereof, or wherein R is C₁₋₆alkyl-CO₂H or a salt thereof, or wherein R is C₁₋₆alkyl-PO₃H₂ or a salt thereof, or wherein R is (CH₂)₁₋₆NH₂ or a salt thereof, or wherein R is (CH₂)₁₋₆NHCH₃ or a salt thereof, or wherein R is (CH₂)₁₋₆N(CH₃)₂ or a salt thereof, or wherein R is (CH₂)₁₋₆N(CH₃)₃⁺OH⁻ or a salt thereof, or wherein R is

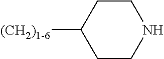

or a salt thereof, or wherein R is

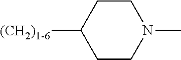

or a salt thereof, or wherein R is

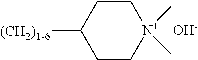

or a salt thereof. Ar^{4′} can be

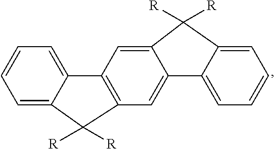

wherein R is C₁₋₆alkyl-SO₃H or a salt thereof, or wherein R is C₁₋₆alkyl-CO₂H or a salt thereof, or wherein R is C₁₋₆alkyl-PO₃H₂ or a salt thereof, or wherein R is (CH₂)₁₋₆NH₂ or a salt thereof, or wherein R is (CH₂)₁₋₆NHCH₃ or a salt thereof, or wherein R is (CH₂)₁₋₆N(CH₃)₂ or a salt thereof, or wherein R is (CH₂)₁₋₆N(CH₃)₃⁺OH⁻ or a salt thereof, or wherein R is

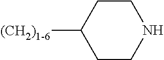

or a salt thereof, or wherein R is

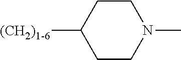

or a salt thereof, or wherein R is

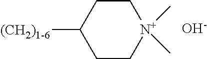

or a salt thereof. Ar^{4′} can be

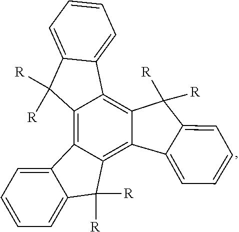

wherein R is C₁₋₆alkyl-SO₃H or a salt thereof, or wherein R is C₁₋₆alkyl-CO₂H or a salt thereof, or wherein R is C₁₋₆alkyl-PO₃H₂ or a salt thereof, or wherein R is (CH₂)₁₋₆NH₂ or a salt thereof, or wherein R is (CH₂)₁₋₆NHCH₃ or a salt thereof, or wherein R is (CH₂)₁₋₆N(CH₃)₂ or a salt thereof, or wherein R is (CH₂)₁₋₆N(CH₃)₃⁺OH⁻ or a salt thereof, or wherein R is

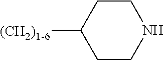

or a salt thereof, or wherein R is

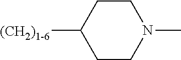

or a salt thereof, or wherein R is

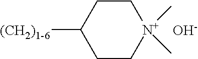

or a salt thereof.

Ar^{5′} is a monomer comprising two or more aromatic rings but not containing any of a terminal C═C double bond, an internal C═C double bond that is not part of an aryl ring, or a C—C triple bond. Ar^{5′} monomers of the disclosure can be selected from, but are not limited to,

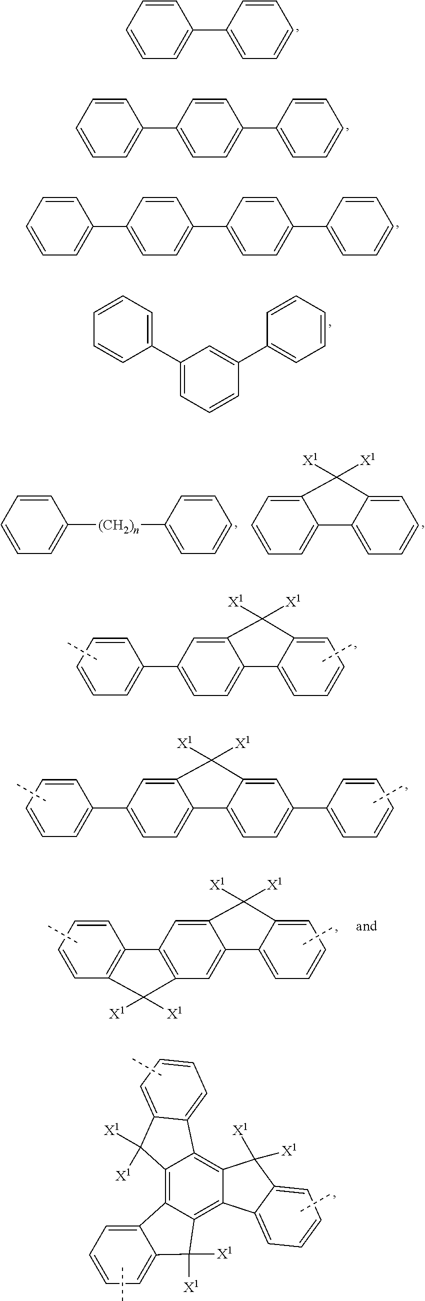

wherein each n is independently selected from 1, 2, 3, 4, 5, and 6, and each X¹ is independently selected from H and C₁₋₆ alkyl.

The ketone-containing monomers are not particularly limited and can generally correspond to precursors of the

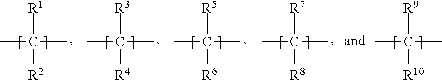

monomer units described above for the repeat units of formula (1), formula (II), formula (III), formula (IV), and formula (V), respectively. Ketone group-containing monomers can be selected from one or more compound of formula (VI), formula (VII), formula (VIII), formula (IX), and formula (X):

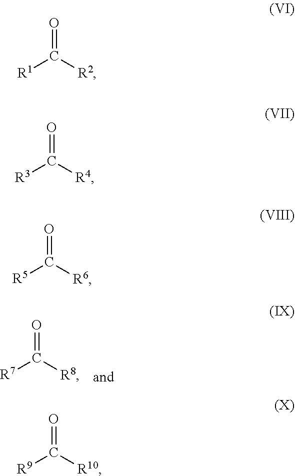

wherein R¹, R², R³, R⁴, R⁵, R⁶, R⁷, R⁸, R⁹, and R¹⁰ are defined in the same way as R¹-R¹⁰ above.

The polymerization can be carried out in a solvent or solvent mixture which is substantially inert to the monomers, polymers, and catalyst, and in which the monomers and catalyst are at least partially soluble. Suitable solvents for the polymerization include, but are not limited to, dichloromethane, chloroform, trifluoroacetic acid, and mixtures thereof.

The polymerization may be carried for a time sufficient to polymerize at least about 50% of the monomers, or at least about 75%, 85%, 90%, 95%, 97%, or 99% of the monomers, or 100% of the monomers. For example, the polymerization may be carried out for a reaction time of up to about 1 h, or up to about 2, 3, 4, 5, 6, 7, 8, 9, 10, 12, 24, 48, or 72 h.

The temperature at which the polymerization is carried out is not particularly limited. For example, the polymerization may be carried out at a temperature in a range of about −20° C. to about 50° C., or about −10° C. to about 40° C., or about 0° C. to about 30° C., or at a temperature of about −20° C., or about −15, −10, −5, 0, 5, 10, 15, 20, 25, 30, 35, 40, 45, or 50° C. The polymerization may be carried out at a single temperature or the temperature may be varied during the polymerization.

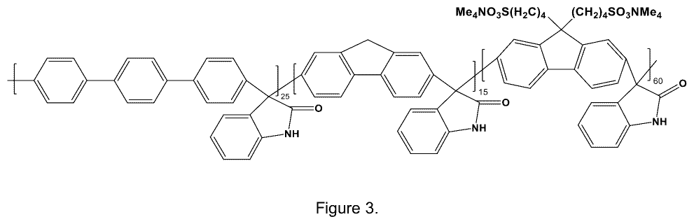

FIG. 3 shows a representation of the composition and structure of Example 3a, a proton exchange polymer according to the disclosure containing FLSN monomer. The polymer shown in FIG. 3 comprises (a) a plurality of repeat units of Formula (IV), wherein Ar⁴ is a monomer unit derived from polymerization of FLSN monomer and R⁷ and R⁸ together with the carbon atom to which they are attached form

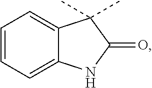

and (b) a plurality of two types of repeat units of Formula (V), wherein Ar⁵ is

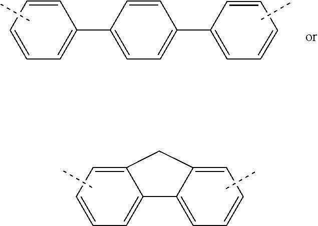

and R⁹ and R¹⁰ together with the C atom to which they are attached form

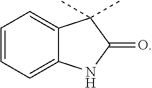

### Membrane Preparation

Membranes comprising polymers of the disclosure can be prepared by any suitable means known in the art, such as a solution casting method. For instance, a polymer solution comprising a polymer of the disclosure and optionally one or more additives dissolved in a suitable solvent can be cast onto a substrate to form a solution layer, followed by solvent removal by application of heat, vacuum, or a combination thereof, to provide a membrane. Membrane thickness can be increased or decreased by adjusting the thickness of the cast solution layer. Membranes reported herein were prepared by solution casting of a dimethyl sulfoxide (DMSO) solution of a polymer unless otherwise noted.

For membranes comprising a proton exchange polymer that contains acid groups in salt form, membrane preparation can include an additional step of converting the salt form to the acid form by treating the membrane with acid. For instance, a membrane comprising a polymer containing sulfonic acid salt groups can be immersed in an acid solution, such as a 1 M HCl solution, to convert the salt form of the acid groups to acid form. For membranes comprising an anion exchange polymer that contains quaternary ammonium groups in salt form, membrane preparation can include an additional step of converting the salt form to the base form by treating the membrane with base. For instance, a membrane comprising a polymer containing quaternary ammonium salt groups can be immersed in a base solution, such as a 1 M NaOH solution, to convert the salt form of the base groups to base form.

### Cross-Linking

Polymers of the disclosure can be subjected to one or more cross-linking conditions to generate a plurality of cross-links between polymer chains. In particular, a membrane comprising a polymer of the disclosure can be subjected to one or more cross-linking conditions to generate a plurality of cross-links between chains of the polymer comprising the membrane.

Cross-linking conditions can include, but are not limited to, irradiating with UV radiation, admixing with a free radical initiator, heating, and combinations thereof. For instance, membranes comprising a polymer of the disclosure containing terminal alkene groups can be treated by UV exposure or by reaction with a free radical initiator to react a plurality of the terminal alkene groups and generate a plurality of cross-links. Cross-linking conditions can be selected to control the amount of cross-links formed. In general, at least a portion of the cross-linkable groups present in the polymer chains are cross-linked. Conditions can be selected to cross-link a majority (i.e., at least 51%) of the cross-linkable groups in the polymer. Conditions can be selected to cross-link substantially all (i.e., at least 90%) of the cross-linkable groups in the polymer. Without intending to be bound by theory, as the amount of cross-linkable groups that are cross-linked increases, the solubility of the polymer can decrease and the mechanical strength of the polymer can increase due to increased effective molecular weight of the polymer.

Free radical initiators are generally known in the art. In general, free radical initiators are compounds that can react or decompose, such as upon exposure to heat or light, to form radical-containing species. Reaction of a membrane of the disclosure with a free radical initiator can include, for instance, immersing the membrane in a solution of the free radical initiator. Suitable free radical initiators for reacting with polymers or membranes of the disclosure can include, but are not limited to, peroxides, peroxy esters, persulfate salts, and azo compounds.

### Membrane Electrode Assemblies

Membrane electrode assemblies (MEAs) are core components of fuel cells and other electrochemical devices. One type of MEA comprises an ion conducting membrane, a catalyst layer, and a gas diffusion layer. The ion conducting membrane (e.g., a proton exchange membrane or anion exchange membrane) can allow selective ion transport; for instance, a proton exchange membrane can allow transport of protons while blocking electrons and larger molecules. The catalyst layer can be composed of one or more ionomers and one or more catalysts, wherein the one or more ionomers can function as a binder and/or an ion conductor within the catalyst layer. The gas diffusion layer can act as a porous medium that enables effective transport of electrons and heat, as well as liquid- and gas-phase reactants and products. Selection of the materials comprising an MEA and fabrication process can impact process safety, device lifetime, and output performance.

Methods of fabricating MEA's are known in the art. For instance, a catalyst ink comprising a catalyst, a solvent, a polymer, and one or more auxiliary components can be coated onto a gas diffusion layer, followed by a hot-press process to attach the layers to a membrane. Alternatively, a catalyst-coated membrane (CCM) process can be used, in which a catalyst ink is applied directly onto a membrane, for instance by spray coating, decal transfer, or other suitable means.

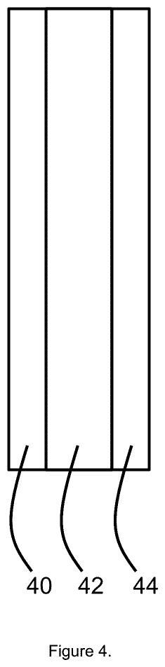

An MEA can also comprise an anode layer, a cathode layer, and an ion exchange membrane disposed between the anode layer and cathode layer, such that the anode layer is in direct contact with a first face of the ion exchange membrane and the cathode layer is in direct contact with a second face of the ion exchange membrane. An MEA of this type is shown schematically in FIG. 4, in which an anode layer 40 is in direct contact with a first face of an anion exchange membrane 42 and a cathode layer 44 is in direct contact with a second face of the anion exchange membrane 42. In this type of MEA, any one, two, or all of the anode layer, cathode layer, and ion exchange membrane can comprise a polymer according to the disclosure. The anode layer can comprise an admixture of an anode catalyst and a polymer according to the disclosure. The cathode layer can comprise an admixture of a cathode catalyst and a polymer according to the disclosure. The ion exchange membrane can be a membrane containing a polymer according to the disclosure. The anode catalyst and cathode catalyst are not particularly limited, and suitable selections will be known to those skilled in the art.

Membranes and polymers of the disclosure can be suitable for use in one or more component layers of an MEA. For instance, an MEA can include an ion conducting membrane comprising a polymer of the disclosure. A catalyst ink comprising the catalyst layer of an MEA can comprise a cross-linkable polymer according to the disclosure. The gas diffusion layer of a membrane electrode assembly can comprise a polymer according to the disclosure.

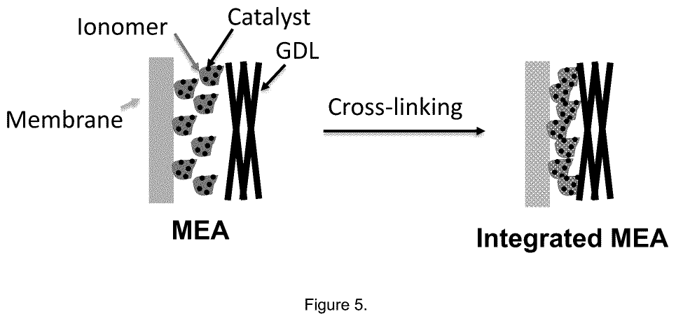

An integrated MEA is contemplated, in which an MEA having two or more adjacent layers that comprise cross-linkable polymers of the disclosure is cross-linked in situ to form a plurality of cross-links between polymers in adjacent layers, in addition to cross-links formed within component layers. Such interlayer cross-linking is expected to provide an MEA having improved contact efficiency, lower impedance, and accordingly higher energy efficiency, compared to an MEA not having a plurality of cross-links between adjacent layers. FIG. 5 shows a representation of an integrated MEA. As shown in FIG. 5, an MEA comprising a membrane, a catalyst layer, and a gas diffusion layer (GDL) can be subjected to cross-linking conditions, bringing the component layers of the MEA into closer contact by forming a plurality of covalent cross-links between the polymers in adjacent layers.

### Membrane Properties

A membrane comprising a polymer according to the disclosure can be characterized by a swelling ratio (SR) in water, as determined by the test method described herein. The membrane can be characterized by a swelling ratio of less than about 50%, or less than about 40%, or less than about 30%, or less than about 20%, or less than about 10%, for example in a range of about 1% to about 50%, or about 1% to about 30%, or about 10% to about 30%, or about 20% to 30%. In general, good membrane performance can be characterized by a swelling ratio of less than about 30%.

A membrane comprising a polymer according to the disclosure can be characterized by its water uptake, as determined by the test method described herein. The membrane can be characterized by a water uptake in a range of about 50% to about 200%, or about 75% to about 200%, or about 100% to about 200%, or about 100% to about 150%, or about 100% to about 125%. In general, good membrane performance can be characterized by a water uptake of greater than about 100%.

A proton exchange membrane comprising a polymer according to the disclosure can be characterized by a proton conductivity, as determined by the test method described herein. The membrane can be characterized by a proton conductivity of greater than about 50 mS/cm, or greater than about 75 mS/cm, or greater than about 100 mS/cm, or greater than about 125 mS/cm, for example in a range of about 50 to about 250 mS/cm, or about 75 to about 250 mS/cm, or about 100 to about 250 mS/cm, or about 150 to 250 mS/cm, or about 150 to 200 mS/cm. In general, good proton exchange membrane performance can be characterized by a proton conductivity of greater than about 150 mS/cm.

An anion exchange membrane comprising a polymer according to the disclosure can be characterized by a hydroxide ion (OH⁻) conductivity, as determined by the test method described herein. The membrane can be characterized by a OH⁻ conductivity of greater than about 50 mS/cm, or greater than about 75 mS/cm, or greater than about 100 mS/cm, for example in a range of about 50 to about 250 mS/cm, or about 75 to about 250 mS/cm, or about 100 to about 250 mS/cm, or about 100 to about 200 mS/cm, or about 100 to about 150 mS/cm. In general, good anion exchange membrane performance can be characterized by a OH-conductivity of greater than about 100 mS/cm.

A gas separation membrane comprising a polymer according to the disclosure can be characterized by a CO₂/N₂ selectivity, as determined by the test method described herein. The gas separation membrane can be characterized by a CO₂/N₂ selectivity or greater than 10, or greater than 20, or greater than 30, or greater than 40, or greater than 50, for example in a range of about 10 to about 200, or about 20 to about 200, or about 30 to about 200, or about 50 to 200, or about 50 to about 150, or about 50 to about 100. In general, good gas separation membrane performance can be characterized by a CO₂/N₂ selectivity of at least 50.

A membrane comprising a polymer according to the disclosure can be characterized by a tensile strength, also referred to herein as max stress, as determined by the test method described herein. The membrane can be characterized by a max stress of at least about 10, 20, 30, 40, or 50 MPa, or up to about 60, 70, 80, 90, or 100 MPa, or within a range formed by any such values as endpoints. In general, good membrane durability can be characterized by a max stress of at least 40 MPa.

A membrane comprising a polymer according to the disclosure can be characterized by a max elongation, as determined by the test method described herein. The membrane can be characterized by a max elongation of at least about 3%, 4%, 5%, 6%, 7%, or 8%, or up to about 10%, 15%, 20%, 25%, 30%, 50%, 100%, 200%, or 300%, or within a range formed by any such values as endpoints.

### Test Methods

To assess solubility of a polymer, membrane, or ionomer in a particular solvent or solvent mixture, a small amount of a sample to be evaluated (typically 0.01-0.1 g) was added to 10 mL of solvent and the mixture was stirred at 50-500 rpm for about 12 hours at about 25° C. The sample was determined by visual inspection to be soluble, insoluble, or partly soluble, based on the amount of remaining undissolved solids. Unless indicated otherwise, solubility of a membrane is a solvent is reported as +(soluble), −(insoluble), or +/−(partly soluble).

CO₂/N₂ selectivity and permeability of gas separation membranes were determined using a continuous-flow gas permeation measurement system. A 47 mm diameter dense membrane sample was loaded to a test cell. The membrane thickness was measured by a micrometer caliper before loading samples to the test cell. The test was performed by using 30% CO₂ (balance N₂) as the feed gas, at 15.7 psig and ambient temperature. The permeate gas was swept by helium to a gas chromatograph for analysis. The concentrations of CO₂ and N₂ in the permeate were used to calculate their flow rates through the membrane. The permeability Pᵢ of gas component i was calculated using equation (1):

$${P}_{i} = ( I \times Ji ) / ( Δ {p}_{i} \times A ) \qquad ( 1 )$$

where Jᵢ is the volumetric permeate flow rate of gas component i (in cm³/s), I is the effective membrane thickness (in cm), A is the effective membrane area (in cm²), and Δpᵢ is the trans-membrane partial pressure difference of gas component I (in cmHg).

The membrane permeability unit, Barrer, is defined as:

$$1 Barrer = {10}^{- 10} {cm}^{3} ( at STP ) \times cm / ( {cm}^{2} \times s \times cmHg ) \qquad ( 2 )$$

where STP indicates standard temperature and pressure (0° C., 1 atm pressure).

The selectivity a(i/j) for a pair of gases i and j (e.g., CO₂/N₂) is defined as the permeability ratio of the gases, as given by equation (3):

$$α ( i / j ) = {P}_{i} / {P}_{j} \qquad ( 3 )$$

Membrane thickness was measured using a digital micrometer (iGaging, San Clemente, CA, USA or equivalent). Individual measurements were taken to the nearest μm, and reported thicknesses are the average of measurements taken at five different areas of the film.

Measurements of membrane swelling ratio, water uptake, and proton conductivity were conducted as follows. Initially, proton exchange membranes in salt form were converted to acid form by soaking several samples of the membrane in 1 M HCl at 80° C. for 24 hours and washed repeatedly with deionized water. Similarly, anion exchange membranes in salt form were converted to base form by soaking several samples of the membrane in 1 M NaOH at 80° C. for 24 hours and washed repeatedly with deionized water. All membranes were immersed in deionized water for 2 hours before testing. After wiping excess water from the surface, a wet sample weight (W_{wet}) was measured. Wet sample thickness, X_{wet}, was measured using a caliper. For proton exchange membrane or anion exchange membrane samples, the in-plane proton or hydroxide conductivity of the wet sample was measured using a four-electrode cell with platinum electrodes submersed in deionized water. Impedance measurements were carried out at open circuit over the frequency range 1-100 kHz, using a Gamry instrument Interface 1010E potentiostat. The wet samples were then dried at about 25° C. followed by drying in an oven at 80° C. to remove excess water. A dry sample weight (W_{dry}) and thickness (X_{dry}) were measured. The water uptake (WU) of each sample was then calculated according to equation (4):

$$WU ( \% ) = ( {W}_{wet} - {W}_{dry} ) ) / {W}_{dry} \times 100 \% \qquad ( 4 )$$

Swelling ratio (SR) was calculated according to equation (5):

$$SR ( \% ) = ( {X}_{wet} - {X}_{dry} ) / {X}_{dry} \times 100 \% \qquad ( 5 )$$

For proton exchange membranes, proton conductivity (σ(H⁺)) was calculated according to equation (6):

$$σ ( {H}^{+} ) ( S / cm ) = L / ( R \times A ) \qquad ( 6 )$$

where L is the distance between the two platinum electrodes (in cm), R is the impedance of the membrane (in Ω), and A is the cross-sectional area of the wet membrane (in cm²), respectively. At least three samples were tested and averaged.

Theoretical ion exchange capacity (“calc. IEC”) of proton exchange polymers, expressed as milliequivalents (meq) of acid groups per gram of dry polymer, was calculated based on the polymer recipe. For proton exchange polymers prepared by polymerizing FLSN monomer, terphenyl, and isatin, the molar ratio of fluorene units (i.e., FLSN monomer) to terphenyl units in the polymer was calculated from the peak areas of the sum of the aromatic proton signals and the sum of the aliphatic proton signals, and the ion exchange capacity was calculated using this ratio (“NMR IEC”).

Selectivity of membranes according to the disclosure for various hydrocarbon pairs was determined as follows. Membrane performance was evaluated using a multi-component synthetic crude oil feed containing multiple hydrocarbons in a dead-end filtration cell (Sterlitech HP4750 or equivalent) at 12 bar and ambient temperature. Concentrations of each hydrocarbon in the permeate stream (Cp) and retentate stream (Cr) were determined using gas chromatography and flame ionization detection (FID). For a given membrane, a separation factor for hydrocarbons 1 and 2 was calculated as (Cp₁/Cr₁)/(Cp₂/Cr₂), where Cp, and Cr, are the concentrations of hydrocarbon 1 in the permeate and retentate, respectively, and Cp₂ and Cr₂ are the concentrations of hydrocarbon 2 in the permeate and retentate, respectively.

Permeate flux was determined by measuring the change in permeate mass over time per square centimeter of membrane area (kg/h/cm²) at a specific transmembrane pressure. Permeance was calculated by dividing the permeate flux by the transmembrane pressure (kg/h/cm²/bar).

Thermogravimetric analysis (TGA) was performed using a STA 449 F3 model thermal analyzer (Netzsch, Selb, GER, or equivalent) from room temperature to 800° C. under nitrogen with a heating rate of 5° C./min.

Max stress (i.e., tensile strength) and max elongation were determined using a universal testing machine (Test Resources Inc., Shakopee, MN, or equivalent). Membranes were cut into 1 inch×2.5 inch rectangular strips prior to testing. Initial grip separation was set at 0.5 inch and crosshead speed was 1 inch/min. In this test, max stress (MPa) is defined as the maximum stress before membrane breaking and was calculated by dividing the maximum load by the initial cross-sectional area of the membrane sample. Max elongation (%) is defined as the maximum elongation of the membrane before breaking, as a percentage of its original length. All reported measurement values were the average of 5 replicates.

¹H-NMR spectra were recorded on a Bruker Avance Ill NMR spectrometer operating at 11.7 T (500 MHz 1H). Dimethyl sulfoxide-d₆ was used as solvent and internal reference (DMSO-d₆, 99.9%, δ(1H)=2.50 ppm).

Reactions described herein can provide polymers that are suitable for membranes, ionomers, or both. It can be recognized that polymers suitable for use as membranes should generally exhibit very low to no solubility in a range of solvents, particularly in polar solvents, including but not limited to water, acetone, methanol, isopropanol (IPA), and any mixtures thereof. It can further be recognized that polymers suitable for use as ionomers should exhibit solubility in one or more solvents, such as water, acetone, methanol, IPA, or mixtures thereof.

### EXAMPLES

The following examples are provided for illustration and are not intended to limit the scope of the invention.

Synthesis of 4,4′-(9H-fluorene-9,9-diyl)bis(butane-1-sulfonic acid, bis(tetramethylammonium) salt) (“FLSN monomer”)

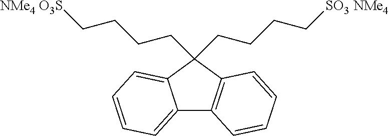

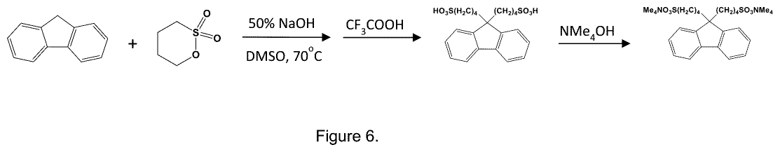

FIG. 6 shows a summary of the synthesis of FLSN monomer. Fluorene (16.62 g, 100 mmol) and 1,4-butane sulfone (34.04 g, 250 mmol) were added to 240 mL of DMSO. The mixture was stirred for one hour under nitrogen and heated to 70° C. to form a homogenous solution. 60 mL of a 50 wt. % aqueous solution of sodium hydroxide was added to the mixture, and the resulting mixture was stirred at 70° C. under nitrogen for 6 h. After cooling to about 25° C., 90 mL of trifluoroacetic acid was added slowly, providing a clear acidic solution. The acidic solution was added to 2 L of acetone to precipitate the crude reaction product, which was collected by filtration, washed several times with acetone, and dried overnight at 80° C. The dried product was recrystallized from 150 mL of 25 wt. % tetramethylammonium hydroxide aqueous solution. The resulting precipitate was redissolved in 20 mL of acetic acid, and the resulting solution was added to 500 mL of acetone to precipitate the product. The resulting product was collected by filtration, washed several times with acetone, and dried under vacuum for 24 hr at 80° C. to yield 26 g (45% yield) of white FLSN monomer.

### Comparative Example 1: Non-Cross-Linkable Anion Exchange Polymers

Comparative anion exchange polymers (i.e., polymers without cross-linking groups) were prepared as follows. Initially, precursor polymers C1a-C1c were prepared according to the recipes and conditions shown in Table 1. In general, dichloromethane (DCM) was added to a mixture of p-terphenyl, N-methyl-4-piperidone (m-PIP), and optionally fluorene to form a suspension, followed by addition of trifluoroacetic acid (TFA) and trifluoromethanesulfonic acid (TFSA). The resulting mixtures were stirred according to the temperature and time conditions listed in the table, after which the resulting solid products were collected by filtration and repeatedly washed to obtain the precursor polymers. The number in the ID of polymers C1b and C1c indicates the mole % of fluorene, based on total moles of aromatic monomer (i.e., fluorene and terphenyl) in the composition.

TABLE 1

| | | Fluorene | p-Terphenyl | m-PIP | DCM:TFA: | |
|---|---|---|---|---|---|---|
| Example | ID | (mmol) | (mmol) | (mmol) | TFSA (mL) | Conditions |
| C1a | T | 0 | 20 | 22 | 10:5:20 | 25° C., 4.2 hr |
| C1b | PNF15 | 3 | 17 | 22 | 10:5:15 | 0° C., 5 hr |
| C1c | PNF30 | 6 | 14 | 22 | 10:2:15 | 0° C., 5 hr |

Anion exchange polymers C1d-C1f were prepared by reacting precursor polymers C1a-C1c, respectively, with iodomethane to convert tertiary amine groups to quaternary ammonium groups with iodide counterion. In general, a precursor polymer, potassium carbonate, and iodomethane were added to dimethyl sulfoxide (DMSO), in the amounts listed in Table 2, and the mixture was stirred for 24 hr at about 25° C. The resulting solid product was collected by filtration, repeatedly washed, and dried to provide the anion exchange polymer as a yellow or off-white solid.

TABLE 2

| | | | Precursor | K₂CO₃ | CH₃I | DMSO | |
|---|---|---|---|---|---|---|---|
| Example | ID | Precursor | (g) | (g) | (mL) | (mL) | Conditions |
| C1d | T-2 | C1a | 7.7 | 2 | 7 | 44 | 25° C., 24 hr |
| C1e | PNF15-2 | C1b | 4 | 1 | 4 | 21 | 25° C., 24 hr |
| C1f | PNF30-2 | C1c | 4 | 1 | 4 | 21 | 25° C., 24 hr |

### Example 1: Cross-linkable Anion Exchange Polymers

Cross-linkable anion exchange polymers were prepared as follows. Initially, precursor polymers 1a-1c were prepared according to the recipes and conditions shown in Table 3. In general, DCM was added to a mixture of trans-stilbene, para-terphenyl, and N-methyl-4-piperidone (m-PIP) to form a suspension, followed by addition of TFA and TFSA, in the amounts listed in Table 3. The reaction mixtures were stirred according to the temperature and time conditions listed in Table 3, and the resulting solid products were collected by filtration, repeatedly washed, and dried to obtain the precursor polymers as light yellow solids. The number in the ID indicates the mole % of stilbene, based on total moles of aromatic monomer (i.e., stilbene and terphenyl) in the composition.

TABLE 3

| | | Stilbene | p-Terphenyl | m-PIP | DCM:TFA: | |
|---|---|---|---|---|---|---|
| Example | ID | (mmol) | (mmol) | (mmol) | TFSA (mL) | Conditions |
| 1a | TS30 | 6 | 14 | 20 | 30:25:25 | 0° C., 3.8 hr |
| 1b | TS70 | 14 | 6 | 20 | 15:20:20 | 0° C., 3.5 hr |
| 1c | TS100 | 20 | 0 | 20 | 15:20:20 | −5° C., 8.1 hr |

Anion exchange polymers 1d-1f were prepared by reacting precursor polymers 1a-1c, respectively, with iodomethane to convert tertiary amine groups to quaternary ammonium groups with iodide counterion. In general, a precursor polymer, potassium carbonate, and iodomethane were added to dimethyl sulfoxide (DMSO), in the amounts listed in Table 4, and the mixture was stirred for 24 hr at about 25° C. The resulting product was collected by filtration, repeatedly washed, and dried to provide the precursor polymer as a yellow or brown solid.

TABLE 4

| | | | Precursor | K₂CO₃ | CH₃I | DMSO | |
|---|---|---|---|---|---|---|---|
| Example | ID | Precursor | (g) | (g) | (mL) | (mL) | Conditions |
| 1d | TS30-2 | 1a | 15 | 3 | 9.5 | 80 | 25° C., 24 hr |
| 1e | TS70-2 | 1b | 5 | 1 | 3.2 | 26 | 25° C., 24 hr |
| 1f | TS100-2 | 1c | 5 | 1 | 3.2 | 26 | 25° C., 24 hr |

Table 5 shows the solubility of the cross-linkable anion exchange polymers of Example 1 in various polar solvents and solvent mixtures. ‘Acetone/water’ denotes a 50:50 (wt:wt) solution of acetone and water.

TABLE 5

| Example | Water | Methanol | Acetone | Acetone/Water | DMSO |
|---|---|---|---|---|---|
| 1c | − | − | − | − | + |
| 1e | − | − | − | +/− | + |
| 1f | − | − | − | + | + |

Example 1d (TS30-2) was insoluble in all solvents tested except DMSO, indicating its potential utility as a membrane polymer. Example 1f (TS100-2) was soluble in acetone/water, indicating potential utility as an ionomer.

### Example 2: Cross-linkable Proton Exchange Polymers

Cross-linkable proton exchange polymers were prepared according to procedures described below. In general, DCM was added to a mixture of p-terphenyl, FLSN monomer, and isatin (indole-2,3-dione) to form a suspension, followed by addition of TFA and TFSA, in the amounts listed in Table 6. The reaction mixtures were stirred under the conditions listed in Table 6, and the resulting products were collected by filtration, repeatedly washed, and dried to obtain proton exchange polymers as off-white or yellow powders. The number in the ID indicates the mole % of FLSN monomer, based on total moles of aromatic monomer (i.e., FLSN monomer and terphenyl) in the composition.

As a representative example, PFLSN60 was synthesized as follows. Anhydrous methylene chloride (22.5 mL) was added to a mixture of FLSN monomer (18 mmol), p-terphenyl (12 mmol), and isatin (31.5 mmol). The mixture was stirred for 5 min to form a suspension. Trifluoroacetic acid (22.5 mL) and trifluoromethanesulfonic acid (45 mL) were added dropwise while cooling the reaction vessel. The reaction vessel was removed from cooling and the reaction was continued for an additional 7.5 hours. The resultant viscous solution was slowly poured into methanol, providing a fibrous solid. The solid was washed with methanol several times to remove residual acid and further precipitated in acetone. After drying at 80° C. overnight, the polymer was dissolved in DMSO to provide a 15% solution. 20 mL of 25 wt. % tetramethylammonium hydroxide aqueous solution was added with stirring, followed by addition of 20 mL of acetic acid. The solution was stirred and added to acetone to precipitate the polymer. The precipitated polymer was shredded into powder using a blender, filtered, washed repeatedly with acetone, and dried at 60° C. under vacuum to provide 15.8 g (96% yield) of PFLSN60.

TABLE 6

| | | FLSN | p-Terphenyl | Isatin | DCM:TFA: | |
|---|---|---|---|---|---|---|
| Example | ID | (mmol) | (mmol) | (mmol) | TFSA (mL) | Conditions |
| 2a | PFLSNO | 0 | 20 | 20 | 25:20:15 | 25° C., 5.0 hr |
| 2b | PFLSN50 | 5 | 5 | 10 | 7.5:7.5:15 | 25° C., 6.5 hr |
| 2c | PFLSN60 | 18 | 12 | 31.5 | 22.5:22.5:45 | 25° C., 7.5 hr |
| 2d | PFLSN65 | 3.5 | 6.5 | 10 | 7.5:7.5:15 | 25° C., 7.0 hr |
| 2e | PFLSN70 | 7 | 3 | 10 | 7.5:7.5:15 | 25° C., 6.5 hr |
| 2f | PFLSN100 | 10 | 0 | 10 | 15:7.5:15 | 25° C., 52 hr |

Example 2 demonstrates preparation of polymers of the disclosure that can be used to make proton exchange membranes. Polymers of this example can be cross-linked by, for instance, reacting amide nitrogens on the backbone with a polyfunctional cross-linker molecule, such as 1,6-dibromohexane or poly(vinylbenzyl chloride), to form covalent cross-links between amide groups.

### Example 3: Cross-linkable Proton Exchange Polymers

Proton exchange polymers were prepared according to procedures described below. In general, DCM was added to a mixture of p-terphenyl, fluorene, FLSN monomer, and isatin to form a suspension, followed by addition of TFA and TFSA, in the amounts listed in Table 7. The reaction mixtures were stirred for 8.5 hr at about 25° C., and the resulting products were collected by filtration, repeatedly washed, and dried to obtain proton exchange polymers as off-white or yellow solids. The numbers in the ID indicate the mole % of FLSN monomer and fluorene, respectively, based on total moles of aromatic monomer (i.e., FLSN monomer, fluorene, and terphenyl) in the composition.

TABLE 7

| | | Terphenyl | Fluorene | FLSN | Isatin | DCM:TFA: | |
|---|---|---|---|---|---|---|---|
| Example | ID | (mmol) | (mmol) | (mmol) | (mmol) | TFSA (mL) | Conditions |
| 3a | PFLSN60-F15 | 2.5 | 1.5 | 6 | 10.5 | 7.5:7.5:15 | RT; 8.5 hr |
| 3b | PFLSN60-F40 | 0 | 4 | 6 | 10 | 7.5:7.5:15 | RT; 8.5 hr |

Example 3 demonstrates preparation of polymers of the disclosure that can be used to make proton exchange membranes. Polymers of this example can be cross-linked by, for instance, reacting amide nitrogens on the backbone with a polyfunctional cross-linker molecule, such as 1,6-dibromohexane or poly(vinylbenzyl chloride), to form covalent cross-links between amide groups. Additional cross-linkable groups can be added to polymers of this example, for instance, functionalizing the fluorene 9-position to incorporate one or more cross-linkable groups, such as vinylbenzyl groups.

### Example 4: Anion Exchange Membranes

Anion exchange membranes were prepared from the anion exchange polymers of Comparative Example C1d (containing no cross-linkable monomer) and Example 1d (containing a 30:70 molar ratio of stilbene:terphenyl) by solution casting a DMSO solution of each polymer. The membranes were evaluated for swelling, water uptake, and OH⁻ conductivity. Results are shown in Table 8. A “-M” tag at the end of an example number indicates the sample is a membrane.

TABLE 8

| | | | | Conductivity |
|---|---|---|---|---|
| Example | ID | Swelling Ratio | Water Uptake | (mS/cm) |
| C1d-M | TS0-2 | 29.0 ± 1.6% | 80% | 108 ± 15 |
| 1d-M | TS30-2 | 32.7 ± 1.8% | 102% | 113 ± 17 |

As seen in Table 8, the cross-linkable membrane of Example 1d-M exhibited higher swelling and water uptake and higher average OH⁻ conductivity compared to the comparative non-cross-linkable membrane.

### Example 5: Proton Exchange Membranes

Proton exchange membranes were prepared from each of the proton exchange polymers of Examples 2b-2f by solution casting a DMSO solution of each polymer. The membranes were evaluated for ion exchange capacity (IEC) and for solubility in a series of polar solvents; results are shown in Table 9. “IPA/water” denotes a 50:50 (wt/wt) solution of isopropanol and water.

TABLE 9

| | IEC (meq/g) | | | | Solubility | | | | |
|---|---|---|---|---|---|---|---|---|---|
| Example | Sample | Calc. | NMR | Water | DMSO | DMAc | Methanol | IPA | IPA/water |
| 2b-M | PFLSN50 | 2.16 | 2.09 | − | + | − | − | − | − |
| 2c-M | PFLSN60 | 2.48 | 2.38 | − | + | − | − | − | − |
| 2d-M | PFLSN65 | 2.63 | 2.57 | − | + | − | − | − | − |
| 2e-M | PFLSN70 | 2.77 | 2.69 | − | + | − | + | − | + |
| 2f-M | PFLSN100 | 3.52 | N/A | swollen | + | − | + | − | + |

For membranes prepared from polymers 2b-2e, the IEC determined by NMR differed from the IEC calculated based on the recipe by no more than 0.1 meq/g, or no greater than about 4%, indicating good agreement between the theoretical and experimental methods. The membrane prepared from polymer 2f swelled, but did not dissolve, in water. The membranes prepared from polymers 2e and 2f were soluble in several polar solvents, indicating that the component polymers can have potential utility as ionomers.

The membranes prepared from polymers 2b-2e were also evaluated for swelling, water uptake, proton conductivity, and mechanical properties. Results are shown in Table 10. Results of measurements on a commercial PFSA membrane, Nafion™ 212, are also included in the table.

TABLE 10

| | | Thickness | Swelling | Water | Conductivity @ | Avg. Max | Avg. Max |
|---|---|---|---|---|---|---|---|
| Example | ID | (μm) | Ratio (%) | Uptake | 80° C. (mS/cm) | Stress (MPa) | Elongation (%) |
| 2b-M | PFLSH50 | 46 | 11.9 ± 0.7 | 52% | 108 ± 1 | 63.2 ± 1.2 | 20.3 ± 1.5 |
| 2c-M | PFLSH60 | 42 | 16.7 ± 1.8 | 55% | 170 ± 1 | 47.1 ± 6.0 | 18.6 ± 2.0 |
| 2d-M | PFLSH65 | 55 | 23.0 ± 0.7 | 80% | 202 ± 2 | 33.5 ± 6.3 | 5.8 ± 1.6 |
| 2e-M | PFLSH70 | 60 | 22.8 ± 0.4 | 96% | 225 ± 1 | Too brittle | |
| — | Nafion ™ 212 | 51 | 15.4 ± 1.6 | 28% | 183 ± 3 | 32 | 343 |

Membranes made from polymers according to the disclosure had superior water uptake and maximum stress compared to a commercial Nafion™ proton exchange membrane. Examples 2c-2e exhibited comparable or superior conductivity compared to that of the commercial membrane.

### Example 6: Gas Separation Membranes

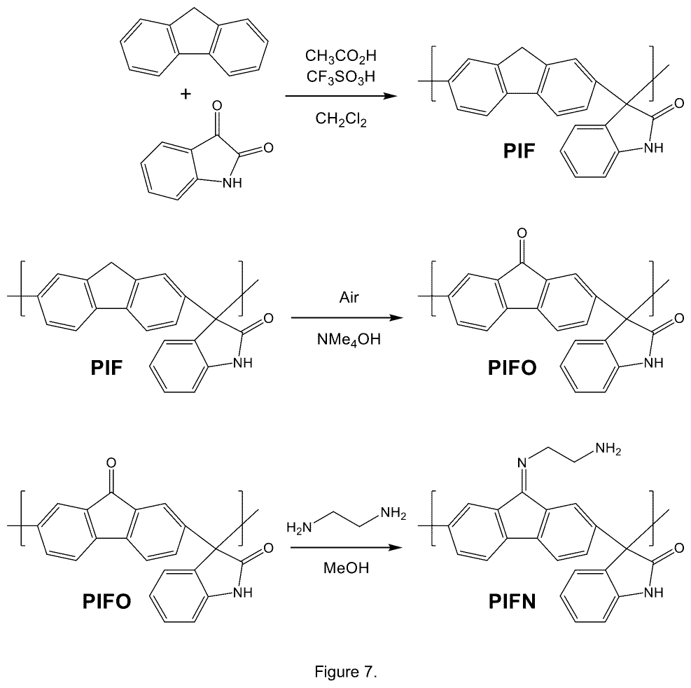

Membranes suitable for use in gas separation applications were prepared as follows. Initially, polymers containing fluorene and isatin monomer units were prepared. Fluorene and isatin, in a molar ratio of about 1:1, were mixed with DMC to form a suspension, followed by addition of TFA and TFSA. The resulting solid was collected by filtration, washed repeatedly, and dried to provide a solid product (‘PIF polymer’; Example 4a). The PIF polymer was solvent-cast into membranes (Example 4a-M) according to membrane preparation methods described herein. Samples of the PIF membrane were immersed in a 25 wt. % solution of tetramethylammonium hydroxide in methanol for 4 days at 60° C. to convert a plurality of fluorene units on the polymer to 9-fluorenone units; the resulting membrane is referred to herein as ‘PIFO’ (Example 4b-M), Finally, a PIFO membrane was immersed in a 25 wt. % solution of ethylenediamine in methanol to convert a plurality of fluorenone units on the polymer to incorporate reactive (aminoethyl)imine groups; the resulting polymer/membrane is referred to herein as ‘PIFN’ (Example 4c-M) Reaction schemes for preparing the polymers of this example are illustrated in FIG. 7.

Another membrane suitable for use in gas separation applications, denoted Example 1 b-M, was prepared from the polymer of Example 1b according to solution casting methods described herein.

Membranes 4a-M, 4b-M, 4c-M, and 1b-M were evaluated for CO₂ permeability and CO₂/N₂ selectivity according to the test methods described herein. CO₂ permeability and CO₂/N₂ selectivity were measured at ambient temperature using a feed gas of 30% CO₂/70% N₂ at a feed pressure of 15.7 psig, with helium as the permeate sweep gas. Results are shown in Table 11.

TABLE 11

| | | Membrane | CO₂ Permeability | CO₂/N₂ |
|---|---|---|---|---|
| Example | ID | Thickness (μm) | (Barrer) | Selectivity |
| 4a-M | PIF | 37 | 14.7 | 61.3 |
| 4b-M | PIFO | 37 | 86.0 | 63.7 |
| 4c-M | PIFN | 37 | 96.9 | 3.5 |
| 1b-M | TS30 | 40 | 23.0 | 92.2 |

Example 6 demonstrates polymers according to the disclosure that are suitable for use as gas separation membranes, as indicated by having good CO₂/N₂ selectivity.

### Example 7: Cross-linked Membranes

Membranes were prepared from the polymer of Example 1d, a cross-linkable anion exchange polymer, by solution casting of a DMSO solution of the polymer. Membrane samples were subjected to UV treatment (i.e., irradiation with 254 nm light for 1, 5, or 10 minutes; membranes 5a-M to 5c-M), KPS treatment (i.e., the membrane was immersed in a 1 wt. % aqueous solution of potassium persulfate for 5, 10, or 20 minutes; membranes 5d-M to 5f-M), or used as cast (i.e., not subjected to cross-linking treatment; membrane 1d-M). Swelling, water uptake, and conductivity data for the untreated and treatment membranes are shown in Table 12.

TABLE 12

| | Cross- | | | | |
|---|---|---|---|---|---|
| Exam- | linking | Solubility | Swelling | Water | Conductivity |
| ple | Treatment | in DMSO | Ratio | Uptake | (mS/cm) |
| 1d-M | None | + | 32.7 ± 1.8% | 102% | 130 ± 10 |
| 5a-M | UV, 1 min | − | 30.3 ± 6.4% | 111% | 129 ± 1 |
| 5b-M | UV, 5 min | − | 35.7 ± 4.1% | 109% | 120 ± 4 |
| 5c-M | UV, 10 min | − | 34.3 ± 2.4% | 107% | 140 ± 6 |
| 5d-M | KPS, 5 min | − | 31.5 ± 0.6% | 112% | 111 ± 7 |
| 5e-M | KPS, 10 min | − | 32.6 ± 1.0% | 105% | 118 ± 4 |
| 5f-M | KPS, 20 min | − | 33.6 ± 2.6% | 99% | 132 ± 3 |

As shown in Table 12, the membrane prior to any cross-linking treatment was soluble in DMSO, while the membranes subjected to UV treatment or KPS treatment under the listed conditions were no longer soluble in DMSO. UV treatment or KPS treatment did not markedly affect the swelling, water uptake, or conductivity of the membranes. Without intending to be bound by theory, it is believed that UV treatment or KPS treatment of the membranes generated a plurality of cross-links with the membrane, as indicated by the loss of solubility in DMSO upon treatment, while not significantly affecting physical or ion exchange properties of the membrane, as indicated by the minor changes in swelling, water uptake, and conductivity upon treatment.

### Example 8: Durable Membranes

Some applications involving the use of membranes require exposure of the membrane to harsh operating conditions, including but not limited high temperature (e.g., for some fuel cell applications) and extreme pH (e.g., alkaline electrolysis). Membranes that can tolerate harsh operating conditions and maintain their function are thus of interest.

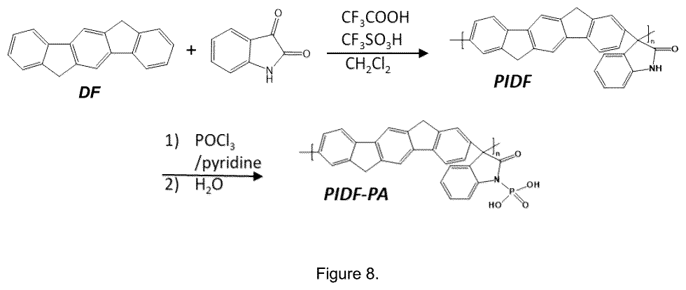

Several ion exchange membranes intended to be suitable for use under harsh operating conditions were prepared. Polymers according to the disclosure comprising 2-phenyl-9H-fluorene (PF) or 6,12-dihydroindeno[1,2-b]fluorene (DF) were prepared and used to make ion exchange membranes, as described below. PF and DF were selected in part to impart rigidity to the resulting membrane. The synthesis of one such polymer, denoted PIDF, using a superacid catalyzed Friedel-Crafts polycondensation reaction is shown schematically in FIG. 8. Equimolar amounts of DF and isatin were charged to a flask and dissolved in anhydrous methylene chloride. TFA and TFSA were then added to the flask dropwise. An ice bath was used to control temperature. The reaction continued for an additional 3 hours, after which the resulting viscous reaction mixture was added to water, producing a fibrous solid. The solid was collected by filtration, washed with water, and dried under reduced pressure at 60° C. Another polymer, denoted PIPF, was synthesized via a similar process using PF and isatin.

A phosphonated polymer, denoted PIDF-PA, was synthesized as shown in FIG. 8 by reacting PIDF with a 2× excess of phosphorus oxychloride (POCI₃) in N-methylpyrrolidone (NMP; 4 wt %) at room temperature, in the presence of pyridine. (Alternatively, 4-dimethylaminopyridine (DMAP) can be used instead of pyridine.) The molar ratio of pyridine to POCl₃ was 1:1. After mixing for 24 h at room temperature, the reaction mixture was added to water in order to precipitate the product. The fibrous precipitate was washed with water 3 times and dried under reduced pressure at 60° C. for 24 h. The ³¹P-NMR spectrum of PIDF-PA polymer showed a single peak at −1.174 ppm, indicating the successful grafting of phosphonic acid groups to the polymer. TGA spectra of PIDF and PIDF-PA showed thermal degradation steps at 196° C., 347° C., and 543° C.

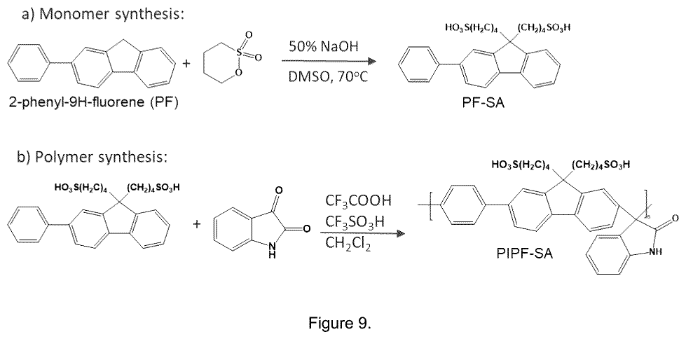

FIG. 9 shows schemes for synthesizing sulfonated monomers and polymers according to the disclosure. A sulfonated monomer, denoted PF-SA, was synthesized by reacting PF with 1,4-butane sulfone in DMSO at 70° C. in the presence of an excess of 50 wt % NaOH aqueous solution. The crude product was purified by recrystallization in a mixture of water and acetone. Another sulfonated monomer, denoted DF-SA, was synthesized by reacting DF with 1,4-butane sulfone under the same conditions used to synthesize PF-SA. A sulfonated polymer, PIPF-SA, was synthesized by reacting PF-SA with isatin using a superacid catalyzed Friedel-Crafts polycondensation reaction with high yields of >95%. Another sulfonated polymer, denoted PIDF-SA, was synthesized by reacting DF-SA with isatin under the same conditions used to synthesize PIPF-SA.

A membrane comprising PIPF-SA was prepared according to methods disclosed herein. The PIPF-SA membrane was smooth and had favorable mechanical properties, including a tensile strength of 76.4±15.0 MPa and an elongation rate of 14.00±2.81%. PIPF-SA has a high theoretical ion exchange capacity of 3.1 mmol/g, which makes the membrane highly conductive to protons. The PIPF-SA membrane exhibited good solubility in DMSO, NMP, and a mixture of DMSO/water/isopropanol, indicating the PIPF-SA polymer has good processability in those solvents and mixtures thereof for membrane production. A TGA spectrum of PIPF-SA showed no significant weight loss until 437° C., indicating excellent thermal stability. An FTIR spectrum of PIPF-SA included absorbances at 1170 cm⁻¹ and 2840-2900 cm⁻¹, attributed to —SO₃H and —CH₂— groups, respectively.

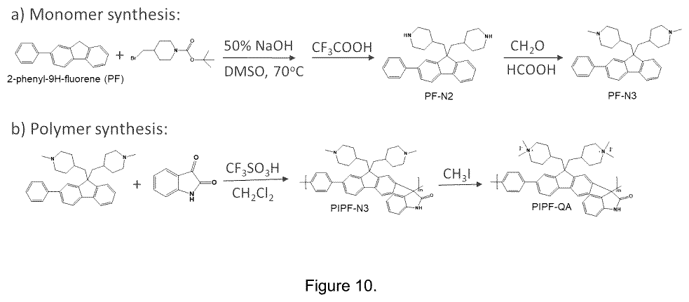

A polymer according to the disclosure suitable for anion exchange was synthesized as shown in FIG. 10. Initially, a tertiary amine monomer was synthesized as shown in FIG. 10a. PF monomer was reacted with tert-butyl 4-(bromomethyl)piperidine-1-carboxylate in DMSO at 70° C. in the presence of an excess of 50 wt % NaOH aqueous solution. The crude product was purified by repeatedly washing with water and hexane. Excess trifluoracetic acid was added to remove the —Boc protecting group. The resulting monomer, denoted PF-N2, contains secondary amines, which were converted to tertiary amines by reacting with formaldehyde in the presence of excess formic acid at 100° C. The resulting monomer, denoted PF-N3, had high purity as characterized by ¹H-NMR. Polymerization of PF-N3 and isatin was carried out as shown in FIG. 10b via a superacid catalyzed Friedel-Crafts polycondensation reaction under conditions used to synthesize PIDF. The resulting polymer, denoted PIPF-N3, formed a colloidal suspension upon stirring in NMP at 100° C. overnight. Finally, PIPF-N3 was reacted with iodomethane to convert tertiary amine groups to quaternary ammonium groups with iodide counterion; the resulting polymer is denoted PIPF-QA.

Polymers according to the disclosure can exhibit a combination of high mechanical strength, high thermal stability, resistance to strong acids and bases, and facile synthesis and scale-up. PIPF- and PIDF-based polymers are generally rigid and aromatic, and membranes comprising these polymers are expected to be durable in harsh operating environments, including but not limited to high temperatures and strongly acidic or basic conditions.

Multilayer membranes fabricated from ion exchange polymers according to the disclosure are contemplated. Such multilayer membranes can be suitable for applications in which high-temperature operation is required, such as in proton exchange membrane fuel cells for heavy-duty transportation applications. For instance, a membrane comprising PIDF-PA can be doped with a small amount of acid (e.g., phosphoric acid) to plasticize the polymer and enhance membrane conductivity, such that a thin membrane (e.g., 10-30 μm) can be prepared. To prevent acid leaching, a very thin barrier layer can be coated on both sides of the membrane. For instance, alternating layers of a negatively charged polymer (e.g., PIPF-SA) and a positively charged polymer (e.g., PIPF-QA) can be coated onto a membrane surface to provide stable protective layer. Without intending to be bound by theory, it is believed that such a protective layer can prevent leaching of acid species (such as phosphoric acid) from a membrane while not significantly interfering with proton exchange.

Use of polymers according to the disclosure in alkaline CO₂ electrolysis is also contemplated. For example, reacting PIF, PIPF or PIDF with KOH can form highly stable oxindole/KOH complex ion pairs, and such polymers can be components of hydroxide-conductive membranes. Additionally, such membranes can become negatively charged in KOH solution and also exhibit low water uptake (<20 wt %), and low swelling (<15%), Such polymers are expected to be suitable for alkaline CO₂ electrolysis in part due to their rigidity, robustness, conductivity, and selectivity.

### Example 9: Microporous Membranes for Gas Separation and Nanofiltration

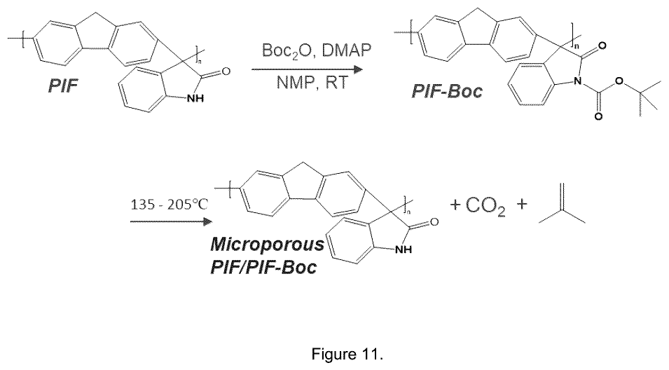

A microporous membrane was prepared as shown in FIG. 11. PIF (see Example 4a) was dissolved in NMP (6 wt %) at room temperature. A 2x excess of di-tert-butyl dicarbonate (Boc₂O) was added to the solution with stirring. A solution of DMAP (0.25 wt. % in NMP) was added dropwise. The mixture was reacted for 1 h at room temperature, then added to water. The resulting white fibrous precipitate was soaked and washed 3 times with methanol.

The product (denoted PIF-Boc) was dried at room temperature overnight and then under vacuum at 60° C. for 24 hours. The yield of the PIF-Boc polymer was >95%. Similar polymers denoted PIPF-Boc and PIDF-Boc were synthesized according to the scheme shown in FIG. 11, starting with PIPF and PIDF, respectively, instead of PIF.

PIF and PIF-Boc have excellent film-forming capability. PIF is soluble in NMP and DMSO, but insoluble in CHCl₃; PIF-Boc is soluble in CHCl₃ and NMP, but insoluble in DMSO. This difference in solubility can be useful during membrane fabrication.

Membranes were prepared by casting a solution of PIF or PIF-Boc on a glass plate using a casting knife to control thickness. After drying, a smooth strong light-yellow film was obtained.

Properties of PIF and PIF-Boc membranes as measured according to test methods described herein are shown in Table 13. PIF and PIF-Boc membranes exhibited good mechanical properties, as indicated by high tensile strength (87.3±4.2 MPa and 65.8±4.4 MPa, respectively) and good elongation rates (8.55±0.46% and 6.08±0.90% respectively).

TABLE 13

| | | Thickness | Max Stress | Max Elongation | Solubility | | |
|---|---|---|---|---|---|---|---|
| Example | Polymer | (μm) | (MPa) | (%) | CHCl₃ | NMP | DMSO |
| 9a-M | PIF | 37.0 | 87.3 ± 4.2 | 8.55 ± 0.46 | − | + | + |
| 9b-M | PIF-Boc | 47.8 | 65.8 ± 4.4 | 6.08 ± 0.90 | + | + | − |

Treating PIF-Boc at high temperature can decompose the Boc group, yielding CO₂ and isobutene, as indicated in FIG. 11. Without intending to be bound by theory, it is believed that this decomposition can result in a membrane having a microporous structure, which will overcome the typical trade-off between permeability and selectivity. Furthermore, it is believed that the conversion degree and the pore structure can be controlled by adjusting the heating conditions (i.e., temperature and time) used to decompose the Boc group. Heating a Boc-containing polymer at a temperature in a range of 135° C. to 205° C. and for a time in a range of 0.1 hr to 12 hr is contemplated.

Table 14 includes data for PIF-Boc membranes subjected to heat treatment at 150° C. under vacuum for 1, 2, 3, or 6 hr (Examples 9c-M, 9d-M, 9e-M, and 9f-M, respectively). Weight loss from the film increased during 150° C. treatment, consistent with decomposition of Boc groups into CO₂ and isobutene. The maximum theoretical weight loss from a PIF-Boc membrane (i.e., degradation of 100% of the Boc groups of PIF-Boc back to the starting secondary amide) is −25.3%; the conversions shown in Table 14 indicate the measured weight loss as a percentage of this maximum theoretical weight loss. The membrane also shrank during heat treatment, losing 18.7% of its original area after 6 hr of heat treatment. Without intending to be bound by theory, it is believed that during the Boc thermal conversion in a membrane, partially converted (i.e., degraded) monomer units can pack in a different manner compared to the original monomer units and that differences in packing of the polymers can be reflected in different combinations of permeability and selectivity relative to the permeability and selectivity of pure PIF and PIF-Boc membranes.

Table 14 also includes data for PIF-Boc membranes subjected to treatment with tetramethylammonium hydroxide (TMAH). PIF-Boc membranes were immersed in a mixture of 25 wt. % TMAH in 2:1 (vol/vol) methanol:DMSO at 80° C. for 1 hr (Examples 9g-M) or 3 hr (Example 9h-M). The PIF-Boc membrane became insoluble in any solvents including CHCl₃, NMP and DMSO within 3 h of TMAH treatment. Without intending to be bound by theory, it is believed that strong base can induce chemical cross-linking in the membrane, for instance through the formation of urea bonds, and that cross-linking can improve membrane stability in organic solvents.

TABLE 14

| | | | | Conversion | | Solubility | | |
|---|---|---|---|---|---|---|---|---|
| Example | Polymer | Treatment | Weight loss | (calc.) | Area loss | CHCl₃ | NMP | DMSO |
| 9c-M | PIF-Boc | 150° C., 1 hr | −4.02% | 15.9% | −2.93% | + | + | − |
| 9d-M | PIF-Boc | 150° C., 2 hr | −11.6% | 45.9% | −9.25% | − | + | − |
| 9e-M | PIF-Boc | 150° C., 3 hr | −18.3% | 72.3% | −13.6% | − | + | +/− |
| 9f-M | PIF-Boc | 150° C., 6 hr | −23.5% | 92.9% | −18.7% | − | + | + |
| 9g-M | PIF-Boc | TMAH, 1 hr | −4.64% | 18.3% | −3.52% | − | +/− | − |
| 9h-M | PIF-Boc | THAM, 3 hr | −11.4% | 45.1% | −7.10% | − | − | − |

CO₂/N₂ permeability and selectivity of PIF and PIF-Boc membranes were evaluated according to methods disclosed herein; results are shown in Table 15. A PIF-Boc membrane (Example 9a-M) exhibited higher permeability, but lower selectivity, compared to a PIF membrane (Example 9b-M). The PIF-Boc membrane subjected to heat treatment for 1 hr of 150° C. under vacuum (Example 9c-M) exhibited improved selectivity (25.4 vs. 3.7) compared to the untreated PIF-Boc membrane. The PIF-Boc membrane subjected to TMAH treatment (Example 9g-M) also exhibited higher permeability (236.4 barrer vs. 177.6 barrer) and selectivity (39.4 vs. 3.7) compared to the untreated PIF-Boc membrane. Without intending to be bound by theory, it is believed that the improved permeability and selectivity of the TMAH-treated membrane are due in part from cross-linking within the membrane induced by treatment with strong base.

TABLE 15

| | | | | CO₂ | |
|---|---|---|---|---|---|
| | | | Thickness | Permeability | CO₂/N₂ |
| Example | Polymer | Treatment | (μm) | (barrer) | selectivity |
| 9a-M | PIF | | 37.0 | 14.7 | 61.3 |
| 9b-M | PIF-Boc | | 47.8 | 177.6 | 3.7 |
| 9c-M | PIF-Boc | 150° C., 1 hr | 52.0 | 167.3 | 25.4 |
| 9g-M | PIF-Boc | TMAH, 1 hr | 47.8 | 236.4 | 39.4 |

Membranes comprising PIF or PIF-Boc can also be suitable for separation of organic solvents. Organic solvent nanofiltration (OSN) membranes were prepared by coating a thin layer of PIF-Boc on a polyacrylonitrile (PAN) ultrafiltration membrane support (PAN-PY, from Synder Filtration). A 0.1% (wt/vol) solution of PIF-Boc in chloroform was applied to the surface of the PAN membrane; the resulting shiny membrane surface indicated the formation of a smooth unform coating layer.

The supported PIF-Boc membrane was evaluated as prepared (Example 9i-M) and following treatment at 80° C. for 3 h (Example 9j-M). Membrane performance was evaluated using a multi-component synthetic crude oil feed as described herein. The composition of the synthetic crude oil is shown in Table 16. Three commercially available OSN membranes were evaluated as comparative examples, denoted as C₉a-M, C9b-M, and C9c-M.

Table 17 shows separation factors for commercial membranes and membranes according to the disclosure for three pairs of hydrocarbon components. Among the commercial membranes, there was almost no selectivity for the pair of bicyclic components 1-methylnaphthalene vs decalin. However, Examples 9i-M and 9j-M exhibited selectivity similar or superior to that of the comparative example membranes. Heat treatment of the PIF-Boc membrane resulted in decrease of the membrane flux, possibly due to pore collapse of the PAN support membrane. However, the selectivity of the PIF-Boc membrane after heat treatment remained higher than the selectivities of the comparative example membranes for the hydrocarbon pairs that were evaluated.

TABLE 16

| Component | MW (g/mol) | Weight % of feed |
|---|---|---|
| Toluene | 92.1 | 13.9 |
| Methylcyclohexane | 98.2 | 24.7 |
| n-Octane | 114.2 | 22.6 |
| Iso-octane | 114.2 | 15.3 |
| Tert-butylbenzene | 134.2 | 2.56 |
| Decalin | 138.3 | 13.1 |
| 1-Methylnaphthanlene | 142.2 | 2.61 |
| 1,3,5-Triisopropylbenzene | 204.4 | 2.73 |
| Iso-cetane | 226.5 | 2.55 |

TABLE 17

| Hydrocarbons 1 and 2 | C9a-M | C9b-M | C9c-M | 9i-M | 9j-M |
|---|---|---|---|---|---|
| 1: Toluene | 1.30 | 1.17 | 1.14 | 1.26 | 1.34 |
| 2: 1,3,5-Trimethylbenzene | | | | | |
| 1: n-Octane | 1.43 | 1.19 | 1.15 | 1.36 | 1.50 |
| 2: Isocetane | | | | | |
| 1: Decalin | 1.03 | 1.01 | 1.02 | 1.08 | 1.08 |
| 2: 1-Methylnaphthalene | | | | | |
| Permeance | 2.52 | 3.44 | 5.70 | 4.57 | 2.94 |
| (kg · m⁻² · h⁻¹ · bar⁻¹) | | | | | |

Because modifications and changes varied to fit particular operating requirements and environments will be apparent to those skilled in the art, the disclosure is not considered limited to the examples chosen for purposes of illustration, and covers all changes and modifications which do not constitute departures from the true spirit and scope of this disclosure.

Accordingly, the foregoing description is given for clearness of understanding only, and no unnecessary limitations should be understood therefrom, as modifications within the scope of the disclosure may be apparent to those having ordinary skill in the art.

Throughout the specification, where the compounds, compositions, articles, methods, and processes are described as including components, steps, or materials, it is contemplated that the compositions, processes, or apparatus can also comprise, consist essentially of, or consist of, any combination of the recited components or materials, unless described otherwise.

1. A polymer comprising a plurality of repeat units of formula (1) 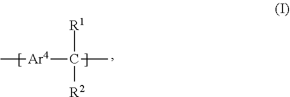
wherein
each Ar¹ is independently a unit comprising two or more aromatic rings and at least one cross-linkable group selected from a terminal C═C double bond, an internal C═C double bond that is not part of an aryl ring, a C—C triple bond, a ketone, and a combination thereof; and
for each geminal pair of R¹ and R², R¹ and R² are independently selected from C₁₋₆ alkyl, C₁₋₆ haloalkyl, C₃₋₁₀ cycloalkyl, C₃₋₁₀ heterocycloalkyl, aryl, and heteroaryl, each optionally having one or more substituents selected from halo, alkyl, aryl, amino, and quaternary ammonium, or R¹ and R², together with the carbon atom to which they are attached, form a carbocycle or heterocycle.

2-143. (canceled)

144. A polymer comprising a plurality of repeat units of formula (IV) 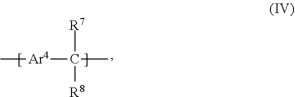
wherein
each Ar⁴ is independently a unit comprising two or more aromatic rings and Ar⁴ has a substituent comprising —SO₃H, —CO₂H, —PO₃H₂, amine, quaternary ammonium, or a salt of any of the foregoing, and Ar⁴ does not contain a terminal C═C double bond, an internal C═C double bond that is not part of an aryl ring, a C—C triple bond, or a ketone; and
for each geminal pair of R⁷ and R⁸, R⁷ and R⁸ are independently selected from C₁₋₆ alkyl, C₁₋₆ haloalkyl, C₃₋₁₀ cycloalkyl, C₃₋₁₀ heterocycloalkyl, aryl, and heteroaryl, each optionally substituted with one or more substituents selected from halo, alkyl, aryl, and amide, or R⁷ and R⁸, together with the carbon atom to which they are attached form a carbocycle or heterocycle,
provided that at least one of R⁷ and R⁸ contains an amide group or at least one geminal pair of R¹ and R⁸, together with the carbon atom to which they are attached, forms a carbocycle or heterocycle that contains an amide group.

145. The polymer of claim 144, further comprising a plurality of repeat units of formula (V) 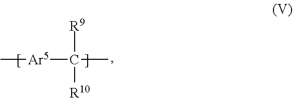
wherein
each Ar⁵ is independently a unit having two or more aromatic rings, wherein Ar⁵ does not contain a cross-linkable group selected from a terminal C═C double bond, an internal C═C double bond that is not part of an aryl ring, and a C—C triple bond, and
for each geminal pair of R⁹ and R¹⁰, R⁹ and R¹⁰ are independently selected from C₁₋₆ alkyl, C₁₋₆ haloalkyl, C₃₋₁₀ cycloalkyl, C₃₋₁₀ heterocycloalkyl, aryl, and heteroaryl, each optionally having one or more substituents selected from halo, alkyl, aryl, and amide, or R⁹ and R¹⁰, together with the carbon atom to which they are attached, form a carbocycle or heterocycle,
wherein at least one geminal pair of R⁹ and R¹⁰, together with the carbon atom to which they are attached, form a carbocycle or heterocycle and the carbocycle or heterocycle has an amide substituent.

146. The polymer of claim 144, wherein each Ar⁴ is independently selected from and 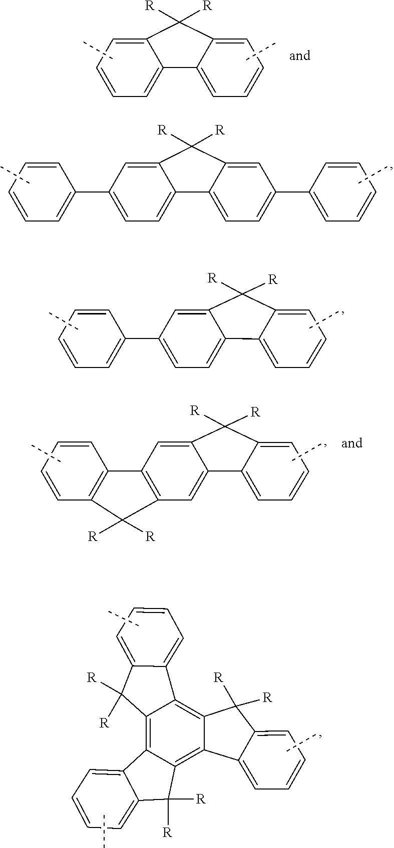
wherein each R is independently selected from C₁₋₆alkyl-SO₃H, C₁₋₆alkyl-CO₂H, C₁₋₆alkyl-PO₃H₂, (CH₂)₁₋₆NH₂, —(CH₂)₁₋₆NHCH₃, (CH₂)₁₋₆N(CH₃)₂, (CH₂)₁₋₆N(CH₃)₃⁺OH⁻, 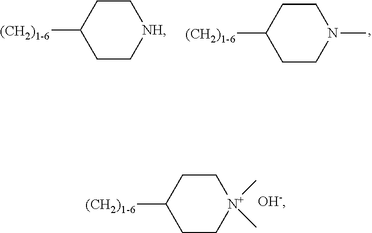
and salts thereof.

147. The polymer of claim 146, wherein at least one Ar⁴ is 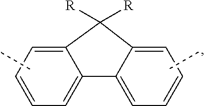
wherein R is selected from C₁₋₆alkyl-SO₃H, C₁₋₆alkyl-CO₂H, C₁₋₆alkyl-PO₃H₂, and salts thereof.

148. The polymer of claim 146, wherein at least one Ar⁴ is 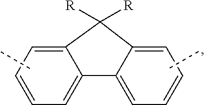
wherein R is C₁₋₆alkyl-SO₃H or a salt thereof.

149-152. (canceled)

153. The polymer of claim 146, wherein at least one Ar⁴ is 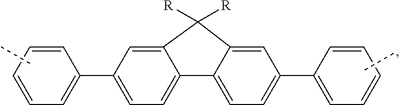
wherein R is selected from C₁₋₆alkyl-SO₃H, C₁₋₆alkyl-CO₂H, C₁₋₆alkyl-PO₃H₂, and salts thereof.

154. The polymer of claim 146, wherein at least one Ar⁴ is 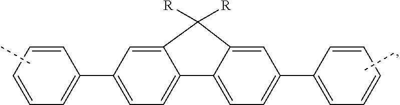
wherein R is C₁₋₆alkyl-SO₃H or a salt thereof.

155-158. (canceled)

159. The polymer of claim 146, wherein at least one Ar⁴ is 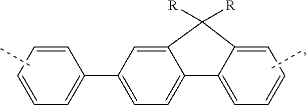
wherein R is selected from C₁₋₆alkyl-SO₃H, C₁₋₆alkyl-CO₂H, C₁₋₆alkyl-PO₃H₂, and salts thereof.

160. The polymer of claim 146, wherein at least one Ar⁴ is 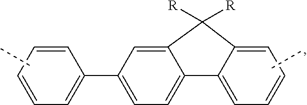
wherein R is C₁₋₆alkyl-SO₃H or a salt thereof.

161-164. (canceled)

165. The polymer of claim 146, wherein at least one Ar⁴ is 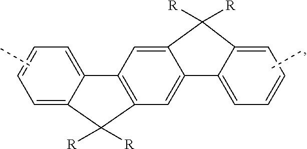
wherein R is selected from C₁₋₆alkyl-SO₃H, C₁₋₆alkyl-CO₂H, C₁₋₆alkyl-PO₃H₂, and salts thereof.

166. The polymer of claim 146, wherein at least one Ar⁴ is 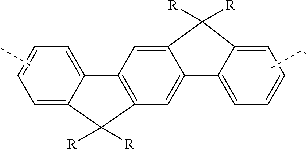
wherein R is C₁₋₆alkyl-SO₃H or a salt thereof.

167-170. (canceled)

171. The polymer of claim 146, wherein at least one Ar⁴ is 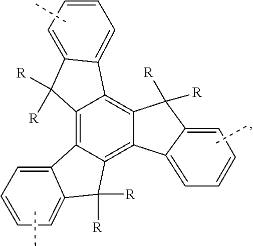
wherein R is selected from C₁₋₆alkyl-SO₃H, C₁₋₆alkyl-CO₂H, C₁₋₆alkyl-PO₃H₂, and salts thereof.

172. The polymer of claim 146, wherein at least one Ar⁴ is 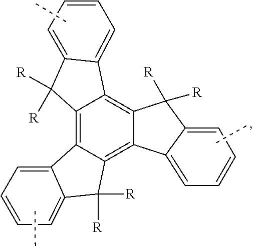
wherein R is C₁₋₆alkyl-SO₃H or a salt thereof.

173-189. (canceled)

190. The polymer of claim 144, wherein at least one geminal pair of R¹ and R⁸, together with the carbon atom to which they are attached, form a heterocycle.

191. The polymer of claim 190, wherein at least one geminal pair of R⁷ and R⁸, together with the carbon atom to which they are attached, form a heterocycle selected from

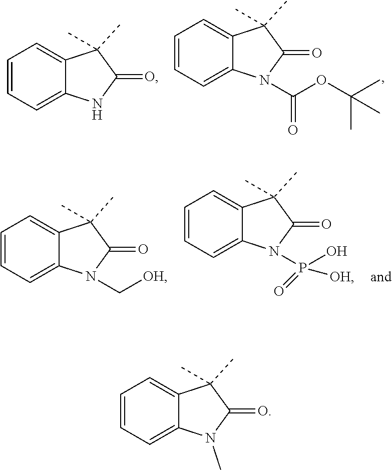

192. The polymer of claim 144, wherein all geminal pairs of R⁷ and R⁸, together with the carbon atoms to which they are attached, form a heterocycle selected from

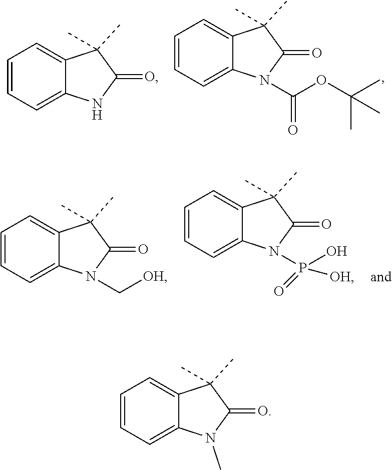

193. (canceled)

194. (canceled)

195. The polymer of claim 145, wherein each Ar^{s} is independently selected from 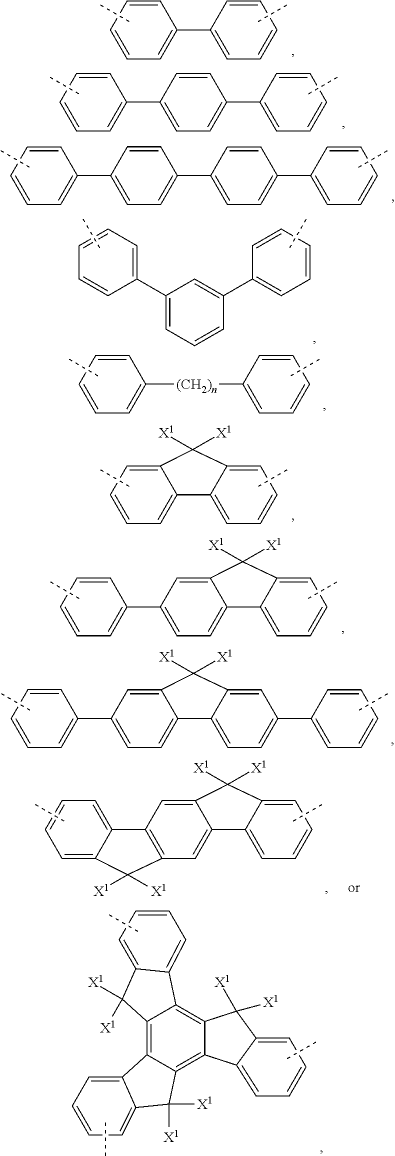
wherein each n is independently selected from 1, 2, 3, 4, 5, and 6, and each X² is independently selected from H and C₁₋₆ alkyl.

196-221. (canceled)

222. The polymer of claim 145, wherein at least one geminal pair of R⁹ and R¹⁰, together with the carbon atom to which they are attached, form a heterocycle.

223. The polymer of claim 222, wherein at least one geminal pair of R⁹ and R¹⁰, together with the carbon atom to which they are attached, form a heterocycle selected from

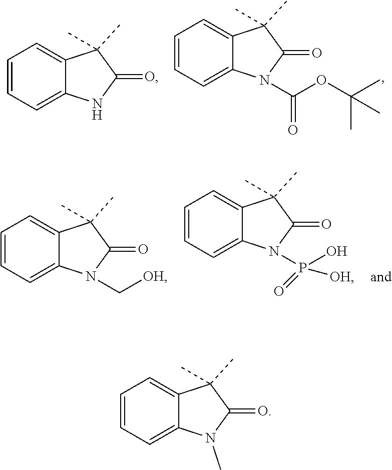

224. The polymer of claim 145, wherein all geminal pairs of R⁹ and R¹⁰, together with the carbon atoms to which they are attached, form heterocycles.

225. The polymer of claim 224, wherein all geminal pairs of R⁹ and R¹⁰, together with the carbon atoms to which they are attached, form heterocycles selected from

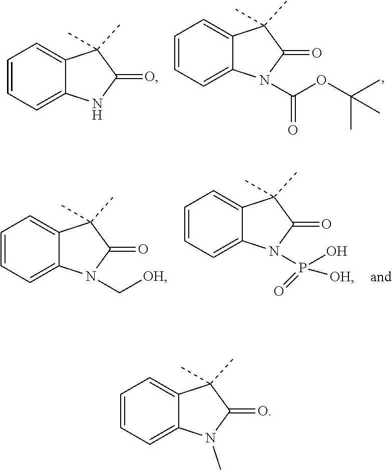

226. (canceled)

227. (canceled)

228. A membrane comprising a polymer according to claim 144.

229. (canceled)

230. A method of making a cross-linked membrane, comprising
(a) providing a membrane comprising a polymer according to claim 144, and
(b) cross-linking at least a portion of the polymers comprising the membrane.

231. (canceled)

232. A cross-linked membrane made by the method of claim 230.

233. A membrane electrode assembly, comprising
(a) an anode layer comprising a polymer according to claim 144 and an anode catalyst,
(b) a cathode layer comprising a polymer according to claim 144 and a cathode catalyst, and
(c) a ion exchange membrane comprising a membrane comprising a Polymer according to claim 144, wherein the ion exchange membrane has a first face and a second face and is disposed between the anode layer and the cathode layer such that the first face is in direct contact with the anode layer and the second face is in direct contact with the cathode layer.

234-236. (canceled)
